(19) United States
(12) Patent Application Publication
(10) Pub. No.: US 2016/0147308 A1
(43) Pub. Date: May 26, 2016

(54) THREE DIMENSIONAL USER INTERFACE

(71) Applicant: REAL VIEW IMAGING LTD., Yokneam (IL)

(72) Inventors: Shaul Alexander GELMAN, RaAnana (IL); Aviad KAUFMAN, Zikhron-Yaakov (IL); Carmel ROTSCHILD, Ganei-Tikva (IL)

(73) Assignee: REAL VIEW IMAGING LTD., Yokneam (IL)

(21) Appl. No.: 14/903,374

(22) PCT Filed: Jul. 10, 2014
(86) PCT No.: PCT/IL14/50626

§ 371 Date: Jan. 7, 2016

Related U.S. Application Data
(60) Provisional application No. 61/844,503, filed on Jul. 10, 2013.

(51) Int. Cl. G06F 3/01; G06F 3/0481

(52) U.S. Cl. CPC G06F 3/017; G06F 3/04815

(57) ABSTRACT

A method of providing a three dimensional (3D) user interface including receiving a user input at least partly from within an input space of the 3D user interface, the input space being associated with a display space of a 3D scene, evaluating the user input relative to the 3D scene, altering the 3D scene based on the user input. A system for providing a three dimensional (3D) user interface including a unit for displaying a 3D scene in a 3D display space, a unit for tracking 3D coordinates of an input object in a 3D input space, a computer for receiving the coordinates of the input object in the 3D input space, and translating the coordinates of the input object in the 3D input space to a user input, and altering the display of the 3D scene based on the user input. Related apparatus and methods are also described.

### RELATED APPLICATION/S

This application claims priority from U.S. Provisional Patent Application No. 61/844,503 filed 10 Jul. 2013. The contents of the above application are incorporated by reference as if fully set forth herein.

### FIELD AND BACKGROUND OF THE INVENTION

The present invention, in some embodiments thereof, relates to a three dimensional user interface and, more particularly, but not exclusively, to a three dimensional user interface which occupies a same space as a three dimensional display.

Three dimensional displays of various sorts are known: apparently three dimensional displays such as stereoscopic three dimensional displays, which appear three dimensional to a human with two eyes, but not necessarily to a fly with a thousand eyes; and true three dimensional displays, such as holographic three dimensional displays, which display objects suspended in the air by crafting light rays which appear to come from an actual object, and which behave the same as light rays coming from an actual object.

A true three dimensional display, such as taught by PCT Published Patent Application WO 2010/004563, displays a scene or an object suspended in the air and allows a user to insert a hand, or a tool, into the space of the display.

Additional background art includes:

US published patent number 2013/091445 of Treadway et al.

US published patent application number 2012/057806 of Backlund et al.

U.S. Pat. No. 8,500,284 to Rotschild et al.

An article titled: “Intracardiac echocardiography for registration of rotational angiography-based left atrial reconstructions: a novel approach integrating two intraprocedural three-dimensional imaging techniques in atrial fibrillation ablation”, by Nölker G, Gutleben K J, Asbach S, Vogt J, Heintze J, Brachmann J, Horstkotte D, Sinha A M, published in Europace. 2011 April; 13(4):492-8.

An article titled: “Intraprocedural imaging of left atrium and pulmonary veins: a comparison study between rotational angiography and cardiac computed tomography”, by Kriatselis C, Nedios S, Akrivakis S, Tang M, Roser M, Gerds-Li J H, Fleck E, Orlov M., in Pacing Clin Electrophysiol, March 2011.

The disclosures of all references mentioned above and throughout the present specification, as well as the disclosures of all references mentioned in those references, are hereby incorporated herein by reference.

### SUMMARY OF THE INVENTION

The present invention, in some embodiments thereof, teaches a method for transforming hand or tool gestures to user-interface commands associated with computer control of contents displayed within a three dimensional display.

In some embodiments, the hand or tool gestures are made within the very space of the three dimensional display.

According to an aspect of some embodiments of the present invention there is provided a method of providing a three dimensional (3D) user interface including receiving a user input at least partly from within an input space of the 3D user interface, the input space being associated with a display space of a 3D scene, evaluating the user input relative to the 3D scene, altering the 3D scene based on the user input.

According to some embodiments of the invention, the input space at least partly overlaps the display space. According to some embodiments of the invention, the input space is included within the display space. According to some embodiments of the invention, the input space overlaps and is equal in extent to the display space.

According to some embodiments of the invention, coordinates of the input space are equal in scale to coordinates of the display space.

According to some embodiments of the invention, the 3D scene is produced by holography. According to some embodiments of the invention, the 3D scene is produced by computer generated holography.

According to some embodiments of the invention, the user input includes the user placing an input object into the input space.

According to some embodiments of the invention, the input object includes the user's hand. According to some embodiments of the invention, the user input includes a shape in which the user forms the hand. According to some embodiments of the invention, the user input includes a hand gesture.

According to some embodiments of the invention, the input object includes a tool.

According to some embodiments of the invention, the user input includes selecting a location in display space corresponding to a location in input space by placing a tip of the input object at a location within the input space.

According to some embodiments of the invention, the user input includes selecting a plurality of locations in display space corresponding to a plurality of locations in input space by moving a tip of the input object through the plurality of locations in the input space and further including adding a select command at each one of the plurality of locations in input space.

According to some embodiments of the invention, the input object includes a plurality of selecting points, and the user input includes selecting a plurality of locations in display space corresponding to a plurality of locations in input space by placing the plurality of selecting points of the input object at the plurality of locations in the input space.

According to some embodiments of the invention, further including selecting an object in display space which is contained within a volume enveloped within the selected plurality of locations in display space.

According to some embodiments of the invention, further including visually altering the display of the location in display space, so as to display the selected location in display space.

According to some embodiments of the invention, further including selecting an object in display space which contains a location corresponding to the selected location in input space.

According to some embodiments of the invention, the input object includes an elongated input object, and a long axis of the input object is interpreted as defining a line which passes through the long axis and extends into the input space.

According to some embodiments of the invention, the user input includes selecting a location in input space corresponding to a location in display space by determining where the line intersects a surface of an object displayed in display space.

According to some embodiments of the invention, further including visually altering the display of a location in display space at which the line intersects a surface of the object displayed in display space, so as to display the selected location in display space.

According to some embodiments of the invention, the user input includes using the line to determine an axis of rotation for a user input of a rotation command.

According to some embodiments of the invention, the user input includes using a selection of two points in display space to determine an axis of rotation in display space.

According to some embodiments of the invention, further including the user rotating the input object, and rotating the 3D scene by an angle associated with the angle of rotation of the input object.

According to some embodiments of the invention, further including the user rotating the input object, and rotating a 3D object selected in the 3D scene by an angle associated with the angle of rotation of the input object.

According to some embodiments of the invention, a displayed object in display space is moved in display space if the input object moves into a location in input space corresponding to a location of the displayed object in display space.

According to some embodiments of the invention, when a point on the input object reaches a location in input space corresponding to a location of the displayed object in display space, a speed of movement of the point on the input object is measured and a direction of a vector normal to a surface of the input object at the point is calculated.

According to some embodiments of the invention, when a point on the input object reaches a location in input space corresponding to a location of the displayed object in display space, a speed of movement of the point on the displayed object is measured and a direction of a vector normal to a surface of the displayed object at the point is calculated.

According to some embodiments of the invention, the displayed object is displayed as moving as if struck by the input object at the point on the displayed object at the measured speed of the point on the input object in a direction of the vector.

According to some embodiments of the invention, selecting a plurality of locations in display space on a surface of a displayed object includes a user input of gripping the displayed object.

According to some embodiments of the invention, a gripping of a displayed object in display space causes the user interface to locate the displayed object in display space so as to track the plurality of locations on the surface of a displayed object at the plurality of selecting points of the input object.

According to some embodiments of the invention, further including altering a shape of a 3D object displayed in the 3D display space by moving the input object through a volume of the 3D object, and displaying the 3D object minus the volume in the 3D object.

According to some embodiments of the invention, further including passing the input object through at least a portion of a volume of a 3D object displayed in the 3D display space, and displaying the 3D object minus the portion of the volume.

According to some embodiments of the invention, the displaying the 3D object includes displaying the 3D object minus only a portion of the volume through which an active region of the input object passed.

According to some embodiments of the invention, further including passing the input object through at least a portion of the input volume, and displaying the 3D scene plus an object displayed in display space corresponding to the portion of the input volume.

According to some embodiments of the invention, the displaying the 3D object includes displaying the 3D object plus only a portion of the volume through which an active region of the input object passed.

According to some embodiments of the invention, further comprising sending a description of 3D object to a 3D printer.

According to some embodiments of the invention, the user input further includes at least one additional user input including an eye gesture selected from a group consisting of winking one eye and winking two eyes.

According to some embodiments of the invention, the user input further includes detecting a snapping of fingers by tracking the fingers in input space.

According to some embodiments of the invention, the user input further includes at least one additional user input selected from a group consisting of a voice command, a head movement, a mouse click, a keyboard input, and a button press.

According to some embodiments of the invention, further including measuring a distance along a path consisting of straight lines between the selected plurality of locations in display space. According to some embodiments of the invention, further including measuring a distance along a path passing through the selected plurality of locations in display space.

According to some embodiments of the invention, the plurality of selected locations in display space are on a surface of a 3D object in display space, and further including measuring an area on the surface of the 3D object enveloped by the plurality of selected locations in display space.

According to some embodiments of the invention, further including measuring a volume of the selected object.

According to some embodiments of the invention, further including selecting a plurality of points in a first image, and a plurality of points in a second 3D image, and co-registering the first image and the second 3D image. According to some embodiments of the invention, the first image is a 2D image. According to some embodiments of the invention, the first image is a 3D image.

According to some embodiments of the invention, further including displaying the first image and the second 3D image so that at least the selected plurality of points substantially coincides in display space.

According to an aspect of some embodiments of the present invention there is provided a system for providing a three dimensional (3D) user interface including a unit for displaying a 3D scene in a 3D display space, a unit for tracking 3D coordinates of an input object in a 3D input space, a computer for receiving the coordinates of the input object in the 3D input space, and translating the coordinates of the input object in the 3D input space to a user input, and altering the display of the 3D scene based on the user input.

According to some embodiments of the invention, the input space at least partly overlaps the display space. According to some embodiments of the invention, the input space is included within the display space. According to some embodiments of the invention, the input space overlaps and is equal in extent to the display space.

According to some embodiments of the invention, the coordinates of the input space are equal in scale to the coordinates of the display space.

According to some embodiments of the invention, the unit for displaying a 3D scene includes a unit for displaying 3D holograms. According to some embodiments of the invention, the unit for displaying a 3D scene includes a unit for displaying computer generated 3D holograms.

According to an aspect of some embodiments of the present invention there is provided a method of providing input to a 3D (three dimensional) display including inserting an input object into an input space with a volume of the 3D display, tracking a location of the input object within the input space, altering a 3D scene displayed by the 3D display based on the tracking, in which the tracking location includes interpreting a gesture.

According to some embodiments of the invention, the input object is a hand, and the gesture includes placing a finger at a location on a surface of an object displayed by the 3D display.

According to some embodiments of the invention, the input object is a tool, and the gesture includes placing a tip of the tool at a location on a surface of an object displayed by the 3D display.

According to some embodiments of the invention, the input object is a hand, and the gesture includes placing a plurality of fingers of the hand together at a same location on a surface of an object displayed by the 3D display.

According to some embodiments of the invention, the input object is a hand, and the gesture includes shaping three fingers of the hand as three approximately perpendicular axes in 3D input space, and rotating the hand around one of the three approximately perpendicular axes.

According to some embodiments of the invention, the input object is a hand, and the gesture includes placing a plurality of fingers of the hand at different locations on a surface of an object displayed by the 3D display, and providing an input of selecting the object.

According to some embodiments of the invention, further including moving the hand. According to some embodiments of the invention, further including rotating the hand.

According to some embodiments of the invention, the input object is a hand, and the gesture includes snapping fingers.

According to some embodiments of the invention, further including the altering the 3D scene including altering the 3D scene at a location which moves as the location of the input object moves.

According to some embodiments of the invention, the 3D scene includes a computerized model, and the altering the 3D scene includes setting a parameter for the model based, at least in part, on the location of the input object, and displaying the model based, at least in part, on the parameter.

Unless otherwise defined, all technical and/or scientific terms used herein have the same meaning as commonly understood by one of ordinary skill in the art to which the invention pertains. Although methods and materials similar or equivalent to those described herein can be used in the practice or testing of embodiments of the invention, exemplary methods and/or materials are described below. In case of conflict, the patent specification, including definitions, will control. In addition, the materials, methods, and examples are illustrative only and are not intended to be necessarily limiting.

Implementation of the method and/or system of embodiments of the invention can involve performing or completing selected tasks manually, automatically, or a combination thereof. Moreover, according to actual instrumentation and equipment of embodiments of the method and/or system of the invention, several selected tasks could be implemented by hardware, by software or by firmware or by a combination thereof using an operating system.

For example, hardware for performing selected tasks according to embodiments of the invention could be implemented as a chip or a circuit. As software, selected tasks according to embodiments of the invention could be implemented as a plurality of software instructions being executed by a computer using any suitable operating system. In an exemplary embodiment of the invention, one or more tasks according to exemplary embodiments of method and/or system as described herein are performed by a data processor, such as a computing platform for executing a plurality of instructions. Optionally, the data processor includes a volatile memory for storing instructions and/or data and/or a non-volatile storage, for example, a magnetic hard-disk and/or removable media, for storing instructions and/or data. Optionally, a network connection is provided as well. A display and/or a user input device such as a keyboard or mouse are optionally provided as well.

### BRIEF DESCRIPTION OF THE DRAWINGS

Some embodiments of the invention are herein described, by way of example only, with reference to the accompanying drawings. With specific reference now to the drawings in detail, it is stressed that the particulars shown are by way of example and for purposes of illustrative discussion of embodiments of the invention. In this regard, the description taken with the drawings makes apparent to those skilled in the art how embodiments of the invention may be practiced.

In the drawings:

FIG. 1A is a simplified illustration of a user providing input in a first input space and viewing a display in a second, different, display space, according to an example embodiment of the invention;

FIG. 1B is a simplified illustration of a user providing input in a display and input space according to an example embodiment of the invention;

FIG. 1C is a simplified block diagram illustration of example input devices and methods which may be used in an example embodiment of the invention;

FIG. 1D is a simplified block diagram illustration of an example embodiment of the invention;

FIG. 2A is a simplified illustration of a portion of a 3D display system according to an example embodiment of the invention;

FIG. 2B is an isometric illustration of a 3D display system according to an example embodiment of the invention;

FIG. 2C is an isometric illustration of a portion of a 3D display system according to an example embodiment of the invention;

FIG. 2D is an isometric illustration of a 3D display system according to an example embodiment of the invention;

FIG. 3 depicts a hand with the fingers of the hand marked from 1 to 5, from the thumb to the little finger;

FIG. 4A is a simplified illustration of a user inserting a hand into a display and input space of a volumetric display according to an example embodiment of the invention;

FIG. 4B is a simplified illustration of a hand making a gesture for selecting a point in an input space according to an example embodiment of the invention;

FIG. 4C is a simplified illustration of a hand making a gesture for selecting a point in an input space according to an example embodiment of the invention;

FIG. 4D is a simplified illustration of a user inserting a tool into a display and input space of a volumetric display according to an example embodiment of the invention;

FIG. 4E is a simplified illustration of a hand making a gesture for rotation in an input space according to an example embodiment of the invention;

FIG. 4F is a simplified illustration of two hands with extended fingers defining a shape of a rectangle in an input space according to an example embodiment of the invention;

FIG. 4G is a simplified illustration of two hands with extended fingers defining a shape of a rectangle in an input space according to an example embodiment of the invention;

FIG. 4H is a simplifies illustration of a user inserting a first 3D object into a display of a second 3D object in a common display and input space according to an example embodiment of the invention;

FIG. 4I is a simplified illustration of a user inserting a tool into a display and input space of a volumetric display according to an example embodiment of the invention;

FIG. 5A is a simplified flow chart illustration of an example embodiment of the invention; and

FIG. 5B is a simplified flow chart illustration of an example embodiment of the invention.

### DESCRIPTION OF SPECIFIC EMBODIMENTS OF THE INVENTION

The present invention, in some embodiments thereof, relates to a three dimensional user interface and, more particularly, but not exclusively, to a three dimensional user interface which occupies a same space as a three dimensional display.

Different kinds of devices and methods for displaying scenes on two-dimensional displays are known, and different kinds of devices and methods for providing a user interface to interact with a scene displayed on a two-dimensional display are known.

For example, moving a computer mouse on a flat surface causes a corresponding cursor to move in corresponding directions on the two-dimensional display. The now-familiar mouse interface derives from movements of the mouse as translated to coordinates of the two-dimensional display.

By way of another example, touching a touch-screen on a two-dimensional computer display causes a computer to sense a location, and sometimes multiple locations. The now-familiar touch and multi-touch interfaces derive from locations and movements of one or more fingers or styli on the two-dimensional display.

In some embodiments of the invention, moving a hand or a tool in a three dimensional (3D) interface space enables a user interface to a 3D display.

In some embodiments of the invention, the 3D interface space partially or fully overlaps with the 3D display space. The user may move a hand or a tool into the display space up to and into the display of a 3D object or a 3D seen. In this manner, the eye-hand coordination of the user is enabled to operate naturally—the hand/tool reaches for an object at the same location at which the eye sees the object. This is in contrast to using a mouse, where the mouse is moved in a different area than the displayed scene. This is similar to touching an object displayed on a touch screen, but in 3D rather than 2D.

In U.S. Pat. No. 8,500,284 to Rotschild et al a 3D holographic display is described where a user can insert a hand or a tool or some other object in a 3D displayed scene without interfering with apparatus which is forming the 3D display. The user also gets the same visual depth cues from the 3D scene and the actual hand or tool. When the hand or tool is at a point in the 3D scene—the user views the same parallax, and focuses to the same distance, for the hand as for the point in the 3D scene.

In some embodiments, a 3D scene is displayed in a 3D display volume, and input for the 3D user interface is received within an input space occupying all or part of a same actual volume in the physical world as the 3D scene in the 3D display volume.

In some embodiments, a 3D scene is displayed in a display volume, and input for the 3D user interface is received within an input space occupying all or part of a same actual volume in the physical world as the display volume.

A potential advantage of receiving input to the 3D user interface in a same volume as the 3D scene or object is displayed is that of hand-eye coordination when hand or tool is in the same location as the displayed object, optionally using a same coordinate system, optionally at a same scale.

A potential advantage of using a floating-in-the-air display such as described in above-mentioned U.S. Pat. No. 8,500,284 is that the entire display volume may be used for input, without restriction caused by a location of display hardware in the display volume.

However, embodiments of the invention should not be limited to a 3D input space occupying a same volume as a 3D display. Some embodiments of the invention operate perfectly well in conjunction with stereoscopic 3D displays and virtual reality 3D displays.

In some embodiments a natural user interface is implemented, where a user reaches for, points to, touches, grips, pushes, pulls, rotates, and so on a displayed 3D object in a 3D scene by using the hand or tool as if actually manipulating a real object in the displayed space. A 3D display system moves the displayed 3D object in the 3D scene by a same amount and direction as the hand or tool, thus providing the visual impression of the hand or tool manipulating the object.

Before explaining at least one embodiment of the invention in detail, it is to be understood that the invention is not necessarily limited in its application to the details of construction and the arrangement of the components and/or methods set forth in the following description and/or illustrated in the drawings and/or the Examples. The invention is capable of other embodiments or of being practiced or carried out in various ways.

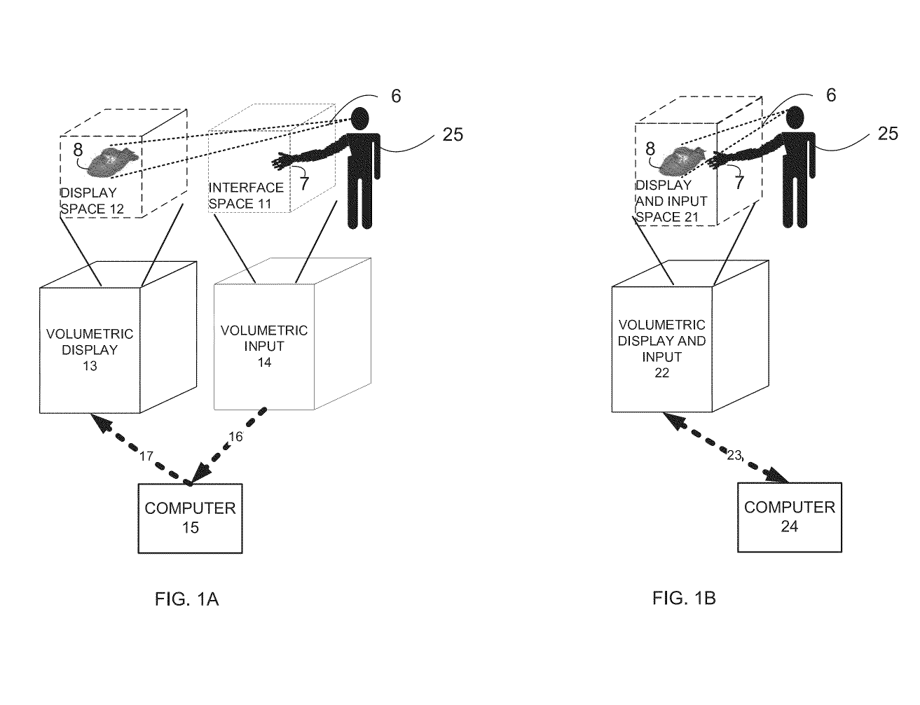

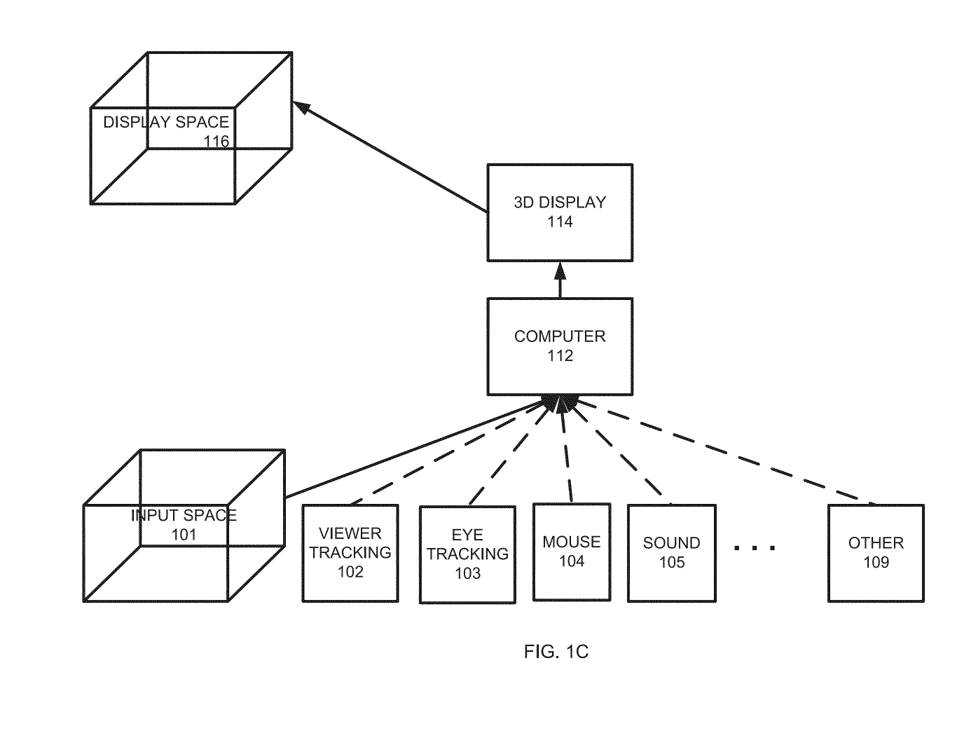

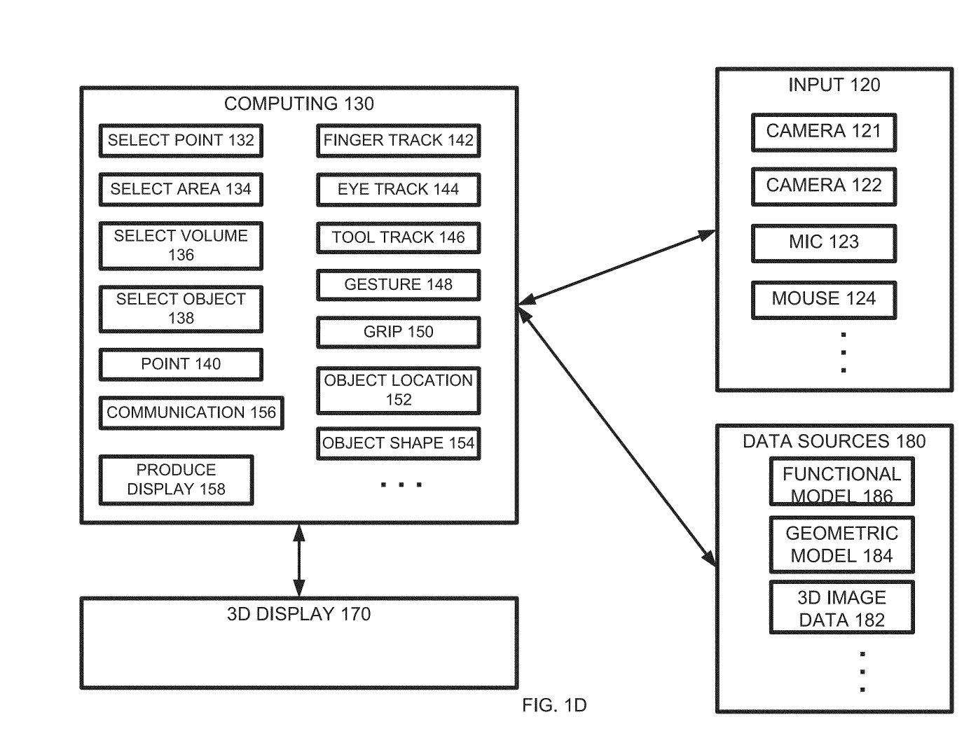

Reference is now made to FIG. 1A, which is a simplified illustration of a user 25 providing input in a first input space 11 and viewing a display in a second, different, display space 12, according to an example embodiment of the invention.

FIG. 1A depicts a computer 15 controlling 17 a volumetric display 13, which displays a 3D object 8 in a scene within the display space 12. The user 25 watches the scene in the display space 12, and uses a hand 7 (by way of a non-limiting example) placed within the input space 11 to provide input 16 to the computer 15, via a volumetric input unit 14.

In some embodiments, the volumetric input unit 14 includes a unit (not shown) for tracking 3D coordinates of an input object, such as the hand 7, in the 3D input space 11.

In some embodiments of the invention, the three dimensional (3D) interface space overlaps the 3D display space, and the hand or tool moves within the scene, or among the objects displayed by the 3D display. Not many displays exist which allow a user to place a hand or tool within the 3D display space.

U.S. Patent Publication No. 2011/0128555 of Rotschild et al teaches a 3D display which allows a user to insert a hand or tool into the very space where the image or scene is displayed, and the displayed image and inserted object provide the same depth cues—the user's eye sees the displayed object and the inserted object with the same parallax, and the user's eye focuses at the same distance for the displayed object same as for the inserted object. Such true 3D viewing enhances the user interface. Typically, the 3D display space contains the elements which are used for displaying the 3D display. However, for example, above-mentioned U.S. Patent Publication No. 2011/0128555 of Rotschild et al teaches a 3D display which allows placing a hand or tool within the scene, or among the objects displayed by the 3D display.

The term “input volume” in all its grammatical forms is used throughout the present specification and claims interchangeably with the term “input space” and its corresponding grammatical forms. The term “input volume” is used throughout the present specification and claims to mean a volume or space in which a user input is picked up, for example by tracking location and/or movement of an input object within the input volume.

The term “display volume” in all its grammatical forms is used throughout the present specification and claims interchangeably with the term “display space” and its corresponding grammatical forms. The term “display volume” is used throughout the present specification and claims to mean a volume or space in which a displayed scene and/or object appears to a viewer.

In some embodiments the display volume is used to display a floating-in-the-air scene or object, into which an input object may optionally be inserted, since the displayed scene or object are occupying a same volume as hardware for displaying the display.

A potential advantage of receiving input to the 3D user interface in a same volume as the 3D scene or object is displayed is that of hand-eye coordination when hand or tool is in the same location as the displayed object, optionally using a same coordinate system, optionally at a same scale.

In some embodiments the display volume is used to display a scene or object which at least partially overlaps a volume taken up by hardware for displaying the display. An example such display volume may be, for example, a stereoscopic display, in which some of a 3D scene optionally juts forward of the stereoscopic display, and some of the 3D scene optionally recedes back from the stereoscopic display. In such a case the display volume includes a volume containing hardware for displaying the display, and the input object may not be free to be optionally inserted into the entire display volume.

Reference is now made to FIG. 1B, which is a simplified illustration of a user 25 providing input in a display and input space 21 according to an example embodiment of the invention.

FIG. 1B depicts a computer 24 controlling 23 a volumetric display and input unit 22, which displays a 3D object 8 in a scene within the display and input space 21. The user 25 watches the scene in the display and input space 21 according to an example embodiment of the invention, and uses a hand 7 (by way of a non-limiting example) placed within the display and input space 21 to provide input 23 to the computer 24, via the volumetric display and input unit 22.

It is noted that in the embodiment of FIG. 1B the display space and the input space coincide, optionally having the same size.

It is noted that in other embodiments the display space and the input space may be of different sizes, occupying different volumes. In some embodiments the input space is smaller than the display space, for example only toward a center of the display space, or toward one side, optionally the side nearer the viewer. In some embodiments the input space is larger than the display space, optionally with tracking components tracking over a larger volume than the 3D display space. In some embodiments the display space and the input space partially overlap, and partially do not overlap. By way of example, the input space may overlap some of the display space, for example the side of the display space nearer the viewer, and the tracking component may track input in the input space further toward the viewer than the display space.

In some embodiments, the volumetric display and input unit 22 includes a unit (not shown) for tracking 3D coordinates of an input object, such as the hand 7, in the 3D display and input space 21.

Many hand and/or body and/or tool gestures will be detailed below, but first, issues of tracking the hand and/or body and/or tool gestures are described.

The term input object will be used herein, in some cases, to mean a hand and/or another body part and/or a tool used for providing user input within a space used as the interface space.

Capturing Input

Various methods of capturing input are used, separately and/or together, in example embodiments of the invention.

In some embodiments a location, in 3D, of an input object is determined, using methods known in the art, and the input object may optionally also be tracked, determining gestures made with the input object. For example, two or more cameras may be looking into a space used as the interface space.

Reference is now made to FIG. 1C, which is a simplified block diagram illustration of example input devices and methods which may be used in an example embodiment of the invention.

FIG. 1C depicts an input space 101, in which monitoring input space, tracking of objects and optional additional methods of input are performed by various methods described herein. Data from the tracking is optionally sent to a computer 112, which optionally analyzes the data, and optionally translates the data to a specific user input.

In response to appropriate user input, the computer 112 optionally sends instructions and/or data to a 3D display 114, which optionally displays a 3D scene in a 3D display space 116.

It is noted that in some embodiments the input space 101 coincides with the 3D display 116, completing a loop. It is also noted that in some embodiments the input space 101 does not coincide with the 3D display 116.

Input from the input space 101 optionally includes location of actual objects, termed herein input objects, inside the input space 101. Optionally, the location of an actual object includes coordinates of one or more points of the input object. Optionally the input from the input space 101 includes higher level description such as an object shape and enough location parameters to describe the object, such as “a cylinder from point A to point B”. Optionally the input from the input space 101 includes even higher level description such as “a hand at coordinates X, Y, Z” and “a finger pointing along direction . . . . ”

Example 3D sensors which can optionally be used for monitoring input space 101 are made by PrimeSense, of 28 Habarzel St. Tel-Aviv, 69710, Israel.

Various optional input devices and methods are also depicted connected to the computer 112, including:

A viewer tracking unit 102;

An eye tracking unit 103;

A mouse input unit 104, which may be a variation on the type, such as a trackball and so on;

A sound input unit 105, whether a microphone connected to the computer 112 or a sound recognition module or a voice recognition module including a processor. It is noted that sound recognition optionally includes not only voice and/or spoken word recognition, but also, for example, the sound a snapping fingers, as mentioned elsewhere herein; and

Some other input unit 109 among the many which is not specified here but is used for input, such as a GPS, accelerometer, light sensor, an acoustic position monitor, and so on.

Reference is now made to FIG. 1D, which is a simplified block diagram illustration of an example embodiment of the invention.

FIG. 1D depicts a computing unit 130 controlling a 3D display 170.

The computing unit 130 optionally accepts input from, and optionally controls operation of, various sources of input 120. The sources of input 120 optionally includes various sensors such as: one or more cameras 121 122; one or more microphones 123 for picking up sounds; a computer mouse 124 or an equivalent input device; and possibly additional inputs such as tilt sensors, GPS, and so on.

The computing unit 130 optionally uses inputs from the sources of input 120, which may include sensors measuring and tracking objects in input space, to determine user inputs for a user interface according to the example embodiment of the invention.

Various computing modules in the computing unit 130 optionally perform analysis of inputs from the sources of input 120, such as:

selecting a point 132 in a 3D scene displayed by the 3D display 170;

selecting an area 134 in the 3D scene displayed by the 3D display 170;

selecting a volume 136 in the 3D scene displayed by the 3D display 170;

selecting an object 138 in the 3D scene displayed by the 3D display 170;

determining a direction in display space where a user's finger or tool are pointing 140;

determining a location of a finger 142 in input space;

determining a direction in display space where a viewer's eye is looking 144;

determining a location of a tool 146 in input space;

classifying a gesture 148 made in input space;

identifying a status of a grip 150 made in input space of an object in display space;

Determining a location of an object 152 in input space;

Determining a shape of an object 154 in input space;

and so on, additional analysis as described herein with reference to the 3D user interface.

The various computing modules in the computing unit 130 also optionally perform communication 156 with additional and/or external modules or systems.

The various computing modules in the computing unit 130 also optionally produce the 3D scene for display 158 by the 3D display 170.

In some embodiments, by way of a non-limiting example an embodiment similar to that depicted in FIG. 1B, the 3D display system is used to determine the location of the input object. The concept is explained further below.

It is noted that a viewer's eyes may be out of the display space.

It is noted that other tracking methods may be used, particularly for hand/tool tracking, such as electro-magnetic, inertial, acoustic, and more.

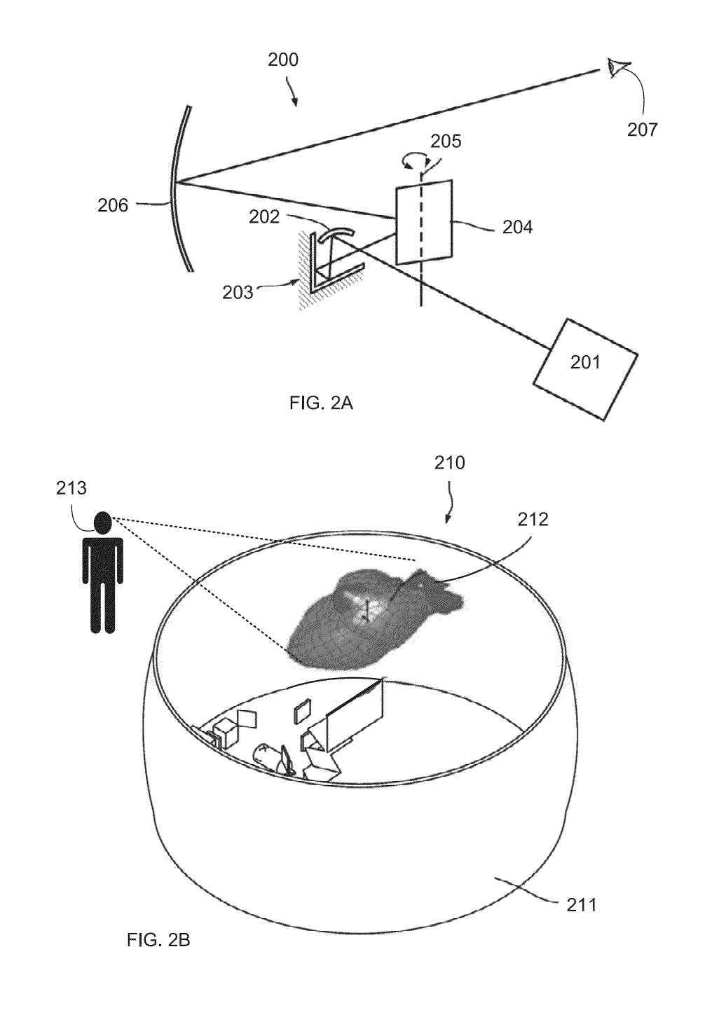

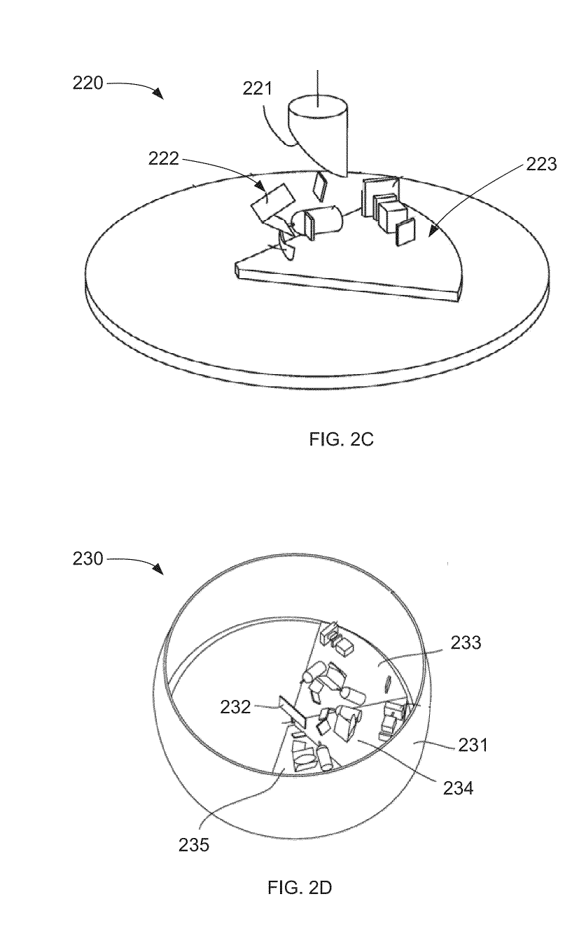

Reference is now made to FIG. 2A, which is a simplified illustration of a portion of a 3D display system 200 according to an example embodiment of the invention.

A system such as depicted in FIG. 2A is described in more detail in above-mentioned U.S. Patent Publication No. 2011/0128555 of Rotschild et al.

FIG. 2A depicts a 3D image generation unit 201, such as, for example a holographic generation unit, projecting a 3D image in a direction which is redirected by mirrors 202 203 onto an optionally revolving mirror 204. The optionally revolving mirror 204 can optionally revolve around an axis 205, changing the direction of projection to follow a user's eye 207.

The projected 3D image is also optionally redirected by an additional mirror 206, which can potentially aid in projecting the 3D image to a space where components of the 3D display system 200 are not present, and do not interfere with insertion of an input object (not shown), allowing the input space to overlap or even coincide with the display space.

Reference is now made to FIG. 2B, which is an isometric illustration of a 3D display system 210 according to an example embodiment of the invention.

FIG. 2B depicts a 3D display system 210 similar to the 3D display system 200 of FIG. 2A, with a circular mirror 211 and a component which tracks a user's 213 eyes and projects an image 212 towards the user's 213 eyes wherever the user 213 goes around the 3D display system 210.

Reference is now made to FIG. 2C, which is an isometric illustration of a portion of a 3D display system 220 according to an example embodiment of the invention.

FIG. 2C depicts a 3D display system 220 similar to the 3D display systems 200 210 of FIGS. 2A and 2B. The 3D display system 220 includes components of a 3D image generation unit occupying a portion 223 of the 3D display system 220, an optionally revolving mirror 222 which redirects the projected image onto an optionally revolving mirror 221, which optionally directs the projected 3D image to a direction of a user. The optionally revolving mirror 222 can be used to also direct incoming light from the user toward an additional component or even several additional components occupying additional portions (not shown) of the 3D display system 220.

Reference is now made to FIG. 2D, which is an isometric illustration of a 3D display system 230 according to an example embodiment of the invention.

FIG. 2D depicts a 3D display system 230 similar to the 3D display systems 200 210 220 of FIGS. 2A, 2B and 2C, with a circular mirror 231 and an optionally revolving mirror 232 which optionally directs light to and from, between a display and input space of the 3D display system 230 and different components 233 234 235 of the 3D display system 230.

The different components 233 234 235 may include a 3D image generation unit, an eye tracking unit, an input object tracking unit, or combinations of the above.

The additional components 233 234 235 may optionally include an eye tracking unit, possibly including a camera, and/or an input object tracking unit such as the unit for tracking 3D coordinates of an input object described with reference to FIGS. 1A and 1B, also possibly including a camera. Optionally, the eye tracking unit and the input object tracking unit use the same camera. Optionally, the input object tracking unit uses a stereoscopic camera, and/or two or more cameras, to determine a three-dimensional location of the input object within the input space, which may optionally overlap or even coincide with the display space.

In some embodiments an eye tracking unit and/or an input object tracking unit are not inside the 3D display system 230. By way of some non-limiting examples, a webcam and suitable software and/or a Kinect system may be used to track a viewer, to track input objects in input space, or to track a user's eyes.

Viewer and Eye Tracking

The 3D display system 230 of FIG. 2D depicts a true three dimensional display, such as taught by PCT Patent Publication No. WO 2010/004563, which can even display a scene or an object suspended in the air and allow a user to insert a hand, or a tool, into the space of the display. Additionally, a viewer tracking unit uses a detector and the revolving mirror 232 to track a viewer from a same direction as the 3D display unit, and in a reverse direction as the viewer views the 3D scene, using some of the same optical path. By adjusting the relative timing of 3D image projection and the viewer tracking unit, based on the frequency of revolution of the revolving mirror, the viewer may be tracked.

In some embodiments, even the direction in which a viewer's eye is looking is tracked, and use made of the information, as is described elsewhere herein. An eye tracking unit, or an additional unit timed to coordinate with the viewer tracking unit, is sited, for example, in one of the additional components 233 234 235 of the 3D display system 230 of FIG. 2D. The unit optionally projects infrared (IR) or near-IR (NIR) light in the viewer's direction. The light is reflected back from the viewer's eye, into the viewer tracking unit.

In some embodiments, a retro-reflection from a back of the viewer's eye is imaged onto the viewer eye detector. In some embodiments an optical Fourier transform of reflection from the viewer's eye is imaged. The eye reflection optionally generates a spot on the Fourier plane, and the spot's center of mass in the Fourier plane indicates the viewer's direction of observation.

In some embodiments, viewer observation direction is tracked by tracking a position of the viewer's pupil and its dark surrounding with respect to the white surrounding eye ball.

Types of Input

In some embodiments, the input for interacting with a 3D display includes a location of an input object in an input space. In some embodiments, the input is a location of a specific point in or on the input object.

In some embodiments, the input is a gesture, a movement of the input object. For example: rotating a hand, moving the input object along a straight line, along a curved path.

In some embodiments, the input is a shape of the input object. For example: a rectangle or a cylinder. Some other examples: a fist; an open hand; a hand with some or all of the finger tips touching; a hand with three fingers held perpendicularly to each other, defining three perpendicular axes.

In some embodiments, an input object is visibly marked so as to enable a tracking or location system using a camera to identify a specific point on the input object.

In some embodiments, input from the input object in an input space is combined with additional inputs, such as computer mouse button clicks, voice commands, keyboard commands, and so on.

Gestures

The ability to generate a 3D image floating in the air allows a user's hands to be placed in the same space as the 3D image. A readout of hand gestures associated with the 3D image potentially enables improved user interaction. Similarly to the way a human eye naturally perceives a 3D image, a hand interaction with the 3D image potentially enables a better, more natural control over the 3D image manipulation and command functions. These natural interface capabilities potentially enhance an intimacy between an image and a viewer.

Throughout the present specification and claims, for purpose of describing fingers of a hand, the fingers are numbered from 1 to 5, from the thumb to the little finger.

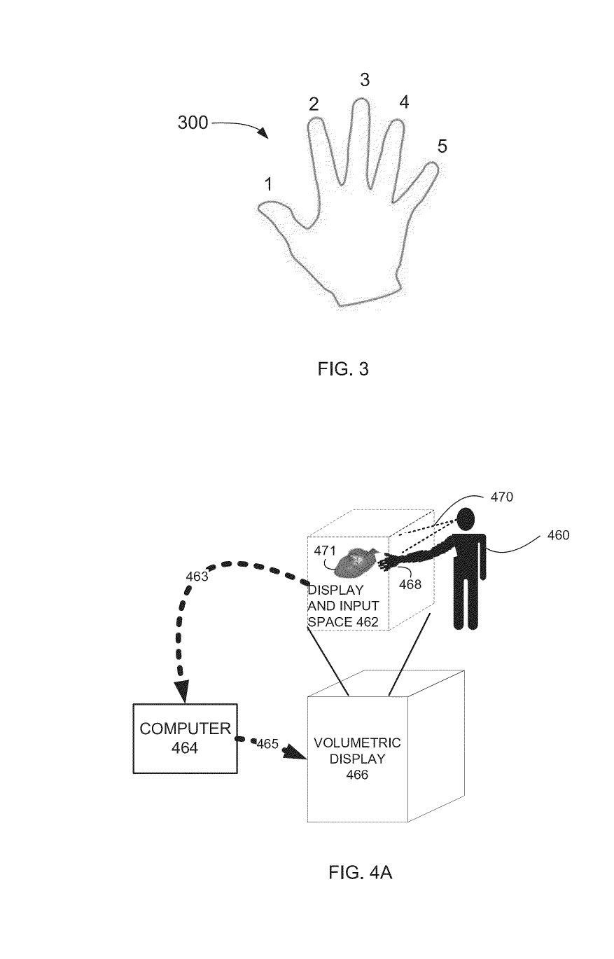

Reference is now made to FIG. 3, which depicts a hand 300 with the fingers of the hand marked from 1 to 5, from the thumb to the little finger.

Some Non-Limiting Examples of Additional Input Sources

In the example embodiments depicted by FIG. 2D, an input can optionally be an eye movement. Since the 3D display system of FIG. 2D tracks a user's eyes, eye movement is optionally picked up by the 3D display system, and optionally serves as input.

By way of a non-limiting example, a wink optionally serves as input. In some embodiments, a wink is accepted as input similar to a mouse click.

By way of a non-limiting example, moving an eye optionally serves as input. In some embodiments, moving an eye up, down, left or right optionally causes the displayed object or scene to rotate up, down, left or right.

By way of a non-limiting example, an eye gesture can mark a location by looking at the location. An eye tracking system optionally tracks the direction which a user's eye is looking, and the user interface optionally intersects the direction with a displayed object. The user optionally marks the location by winking, or blinking, one specific eye, or both eyes. In some embodiment, by way of a non-limiting example, winking with a left eye is set to be equivalent to clicking a left mouse button, and winking with a right eye is set to be equivalent to clicking a right mouse button.

By way of another non-limiting example, an eye gesture can perform a selection from a menu, or replace a mouse click when needed.

In some embodiments, an input can optionally be a voice command.

An Example Embodiment of a 3D User Interface Command—Snapping Fingers

In some embodiments, a user inserts a hand into input space, and snaps fingers. The snapping of the fingers is optionally detected within input space, and translated as an activation comment. The activation command may optionally be equivalent to a mouse click, and/or may cause some other manifestation of a user interface command, such a bringing up a menu display, ending or suspending a computer process (similar to Control-C or Control-Z), and so on.

In some embodiments the finger snapping command is optionally provided by a microphone pickup and an analysis of the snapping sound.

In some embodiments the finger snapping command provided by detecting the gesture in input space is additionally supported by a microphone pickup and analysis of the snapping sound.

An Example Embodiment of a 3D User Interface Command—Selecting a Point in Image Space

In some embodiments, a point in a scene or on an object is selected by a user providing input, and the selected point is optionally displayed by the 3D display, for example by highlighting the point or selection.

Throughout the present specification and claims, when a selection of a point, path, menu option, object in the 3D scene and so forth are described, it is also meant that the selection is optionally displayed, optionally by highlighting the selected point, path, menu option, object in the 3D scene and so forth.

In some embodiments, the selection is performed by a hand gesture.

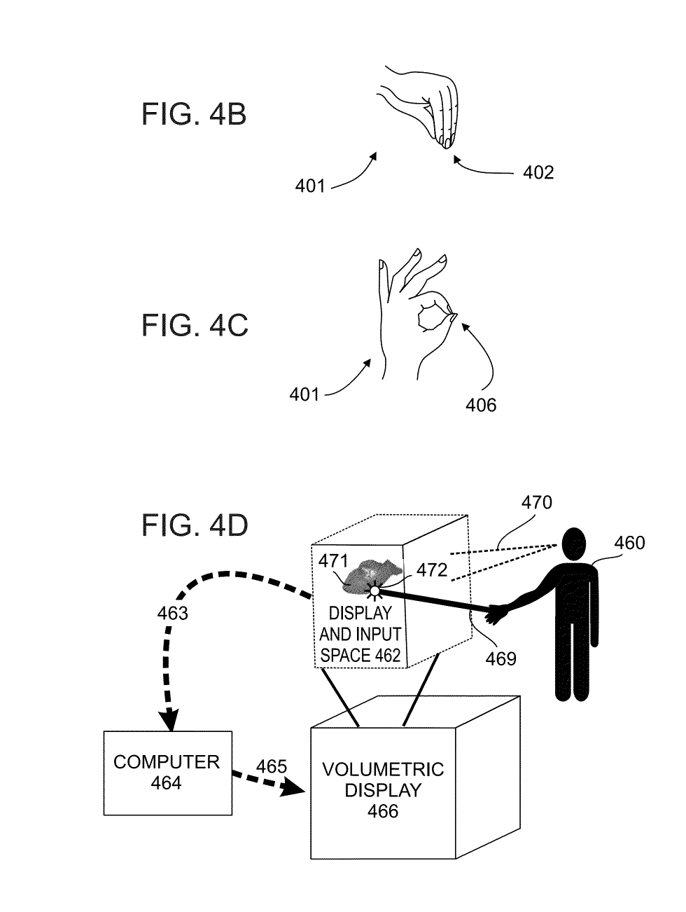

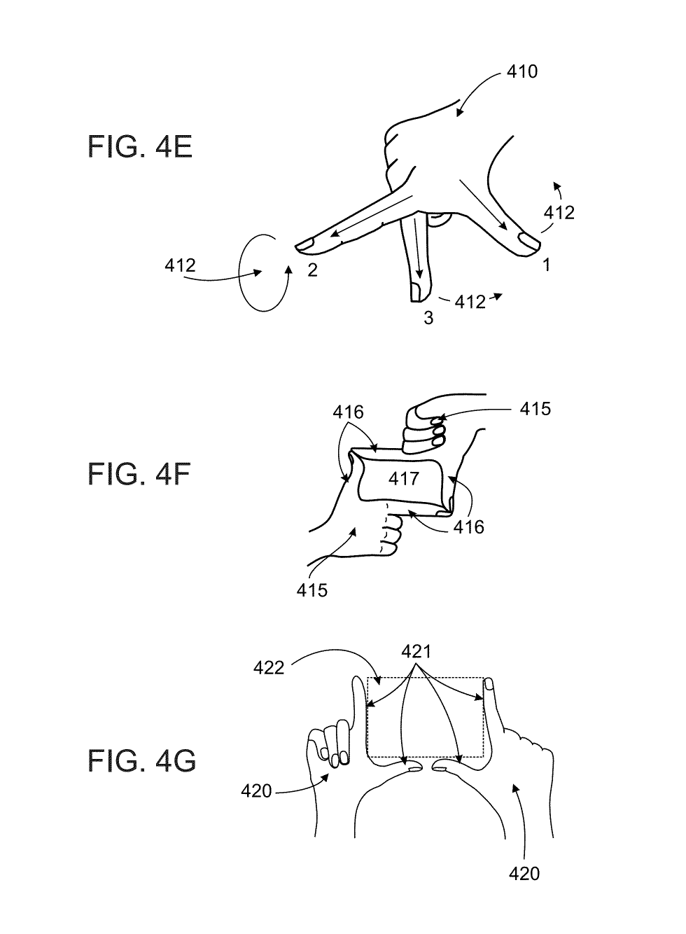

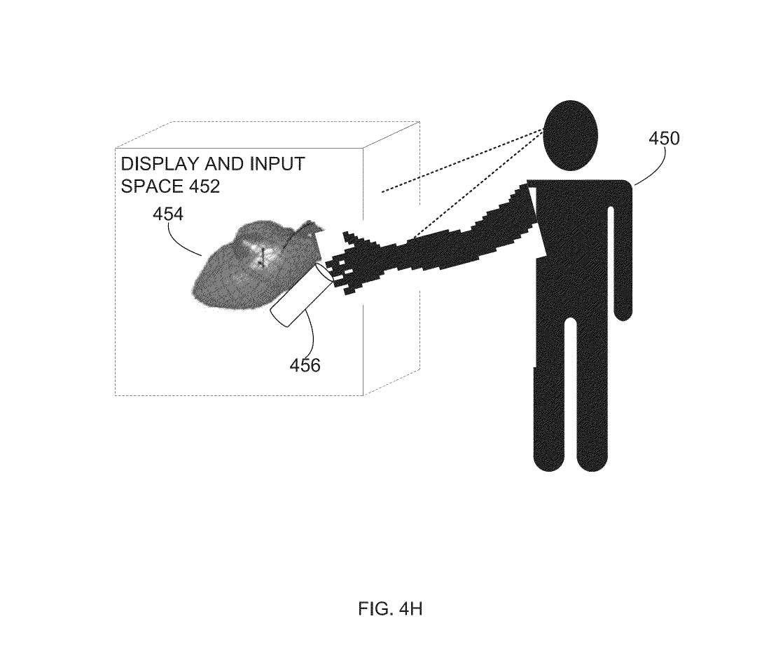

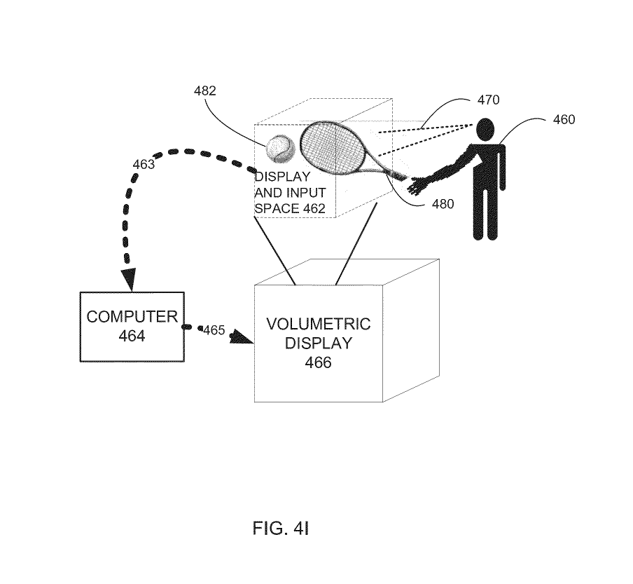

Reference is now made to FIG. 4A, which is a simplified illustration of a user 460 inserting a hand 468 into a display and input space 462 of a volumetric display 466 according to an example embodiment of the invention.

FIG. 4A depicts the volumetric display 466 displaying a 3D object 471, in this example a 3D image of a heart, optionally generated from a medical data set. The user's hand 468 is in the input space of the 3D display system, and the input space of the 3D display system corresponds to and overlaps with the 3D display space. The user can select a point on the 3D object 471 by extending a hand or a tip of a finger of the hand, to reach a point in the display and input space 462 which the user 460 sees 470 displayed. The point which the user selects by touching is an input in an input space. The input is transferred 463 to a computer 464, which processes the input and optionally generates data for producing a 3D image with the point optionally marked as selected. The data for producing the 3D image is sent 465 to a volumetric display 466 which displays the 3D image with the point optionally marked as selected in the display and input space 462.

It is noted that touching a 3D object displayed in display space does not a sensory input of touching, like pressure on the tips of a finger, or like an obstruction to moving a tool into the object.

In some embodiments, a sense as of touching is optionally produced. By way of a non-limiting example, a tool is vibrated when the tool, or the tool tip, touches an object in the 3D display. By way of another non-limiting example, a sharp puff of compressed air is blown toward a finger, hand, or tool when the finger, hand, or tool, touches an object in the 3D display.

It is noted that defining when an object in a 3D display is touched by an input object in input space optionally depends on resolution of one or both of the 3D display and a tracking system which tracks objects in input space.

In some embodiments, the hand gesture is a closing of all the hand's fingers around, for example finger 2, the tip of finger 2 optionally identifying the point. In some embodiments, the action of closing of all the hand's fingers around finger 2 activates the selection. In some embodiments, an additional user action activates the selection, such as, by way of a non-limiting example, an eye blink, a voice command such as “mark”, or a mouse click.

Reference is now made to FIG. 4B, which is a simplified illustration of a hand 401 making a gesture for selecting a point 402 in an input space according to an example embodiment of the invention.

In some embodiments, the hand gesture is a pointing of a finger, for example finger 2, at a point on a 3D object. A direction of the pointing of the finger is optionally calculated by a computer optionally picking up the direction of the finger as input, and a location of the point is calculated at an intersection of the direction of the finger pointing and a surface of the displayed 3D object.

In some embodiments, the point of intersection is highlighted, displaying the point to which the finger points, and the highlight moves as the direction changes.

In some embodiments, an additional user action activates the above-mentioned selection, such as, by way of a non-limiting example, an eye blink, a voice command such as “mark”, or a mouse click. In some embodiments, a selection point which has been activated is highlighted differently than the point to which the finger points, such as, by way of a non-limiting example, highlighted by a different color and/or by a different intensity.

In some embodiments, the hand gesture is a touching of tips of two fingers, such as, by way of a non-limiting example, a touching of the tip of finger 1 to the tip of finger 2, the point of touching optionally identifying the point. In some embodiments, the action of the touching of the finger tips activates the selection. In some embodiments, an additional user action activates the selection, such as, by way of a non-limiting example, an eye blink, a voice command such as “mark”, or a mouse click.

Reference is now made to FIG. 4C, which is a simplified illustration of a hand 405 making a gesture for selecting a point 406 in an input space according to an example embodiment of the invention.

In some embodiments, the selection is performed by an eye gesture. The user looks at a point on a 3D scene and/or 3D object being displayed by the 3D display, and the point at which the user is looking is calculated and optionally marked as selected on the 3D display.

Reference is now made to FIG. 4D, which is a simplified illustration of a user 460 inserting a tool 469 into a display and input space 462 of a volumetric display 466 according to an example embodiment of the invention.

FIG. 4D depicts the volumetric display 466 displaying a 3D object 471, in this example a 3D image of a heart, optionally generated from a medical data set. The tool 469 is in the input space of the 3D display system, and the input space of the 3D display system corresponds to and overlaps with the 3D display space. The user can select a point on the 3D object 466 by extending the tool, to reach a point 472 in the display and input space 462 which the user 460 sees 470 displayed. The point 472 which the user selects by “touching” as will be described below, is an input in an input space. The input is transferred 463 to a computer 464, which processes the input and optionally generates data for producing a 3D image with the point 472 optionally marked as selected. The data for producing the 3D image is sent 466 to a volumetric display 466 which displays the 3D image with the point 472 optionally marked as selected in the display and input space 462.

In some embodiments, the selection is performed by a tool. The tool tip is optionally placed at a point in the display space, to select the point.

In some embodiments, an additional user action activates the above-mentioned selection, such as, by way of a non-limiting example, an eye blink, a voice command such as “mark”, or a mouse click.

In some embodiments, the selected point is optionally displayed by the 3D display, for example by highlighting the point or selection.

In some embodiments, the tool is used to point at a point on a 3D object. A direction of the pointing of the tool is optionally calculated by a computer optionally picking up the direction of the tool as input, and a location of the point is calculated at an intersection of the direction of the tool pointing and a surface of the displayed 3D object.

In some embodiments, the point of intersection is highlighted, displaying the point to which the tool points, and the highlight moves as the direction of the tool pointing changes.

In some embodiments, an additional user action activates the above-mentioned selection, such as, by way of a non-limiting example, an eye blink, a voice command such as “mark”, or a mouse click. In some embodiments, a selection point which has been activated is highlighted differently than the point to which the tool points, such as, by way of a non-limiting example, highlighted by a different color and/or by a different intensity.

An Example Embodiment of a 3D User Interface Command—Selecting a Path in 3D Image Space

Optionally, multiple activations mark multiple points.

In some embodiments a computer describes a path between the multiple points. In some embodiments the path includes straight lines between the multiple selected points. In some embodiments the path is a smoothed line passing through the multiple selected points, and/or a line passing near the multiple points.

In some embodiments, marking the path in the 3D image space includes closing all fingers except, for example, finger 2, such that the tip of finger 2 defines a location in space, and moving the tip of finger 2 along a path.

In some embodiments, the action of closing of all the hand's fingers except finger 2 activates a beginning of the path, and as long as the fingers are closed, the selecting of the path continues. In some embodiments, an additional user action activates the selection, such as, by way of a non-limiting example, a mouse click. In some embodiments as long as the mouse button is pressed the selecting of the path continues. In some embodiments a second mouse click terminates the selecting of the path.

In some embodiments, marking the path in the 3D image space includes using a tool tip to define a location in space, and moving the tool tip along a path.

In some embodiments, an additional user action activates the selecting of the path, such as, by way of a non-limiting example, a mouse click. In some embodiments as long as the mouse button is pressed the selecting of the path continues. In some embodiments a second mouse click terminates the selecting of the path.

In some embodiments, a button click on the tool is optionally used to start and/or end selecting the path.

In some embodiments the selecting and optional marking of a path includes marking including a choice of color for the marking, type of brush for the marking, width of brush for the marking. Selecting the color/brush/width is optionally by a menu selection, the menu is optionally displayed within the 3D display.

In some embodiments, a brush which is displayed by the 3D display is gripped and moved, as gripping and moving an object are described herein, and at a certain point marking (painting) a path with the brush is activated.

In some embodiments, an actual brush is inserted into input space, and the user interface tracks the tip of the bristles of the brush. When marking of the path is activated, the path through which the tip of the bristles of the brush moves is tracked, and optionally marked.

An Example Embodiment of a 3D User Interface Command—Selecting a Plane in Image Space

Optionally, multiple activations mark multiple points.

In some embodiments a computer calculates a plane passing through three or more points selected by any of the above-described methods.

An Example Embodiment of a 3D User Interface Command—Selecting an Object in a 3D Scene

In some embodiments an object in a 3D scene is optionally selected by using an input object in the input space.

In some embodiments, selecting a point on the object, for example by any of the above-described methods, optionally causes the entire object to be selected.

In some embodiments, selecting a point on or in the object, for example by any of the above-described methods, optionally causes a specific layer defined in the object to be selected. Optionally, when the point selected is within the object, the layer selected is a layer equidistant from a surface of the object.

In some embodiments, the selected object is highlighted in the 3D scene. Such highlighting optionally communicates to a user which object has been selected.

By way of a non-limiting example, when the 3D scene displayed is a medical scene, an object selected may optionally be a specific organ in the medical image, and/or a specific system (such as bones, muscles, blood vessels) in the medical image, which a computer used for generating the image optionally recognizes, potentially by generating the 3D scene from medical data.

An Example Embodiment of a 3D User Interface Command—Gripping an Object in a 3D Scene

In some embodiments, an object displayed in a 3D scene may optionally be gripped. Gripping an object enables a user to cause the 3D display to move the object in some way defined by a movement of the input object.

In some embodiments a point of gripping is defined in a 3D image space, by closing fingers 1, 2 and 3 at a point in input space corresponding to a point in or on the object, in image space. The gripping optionally enables moving a gripped object by movement of the hand, optionally as long as the fingers 1, 2 and 3 keep gripping.

In some embodiments a point of gripping is defined in a 3D image space, by closing fingers 1 and 2 at a point in input space corresponding to a point in or on the object, in image space. The gripping optionally enables moving a gripped object by movement of the hand, optionally as long as the fingers 1, 2 and 3 keep gripping.

In some embodiments gripping is emulated in a 3D image space, by placing a tool tip at a point in input space corresponding to a point in or on the object, in image space, and optionally activating a grip emulation.

In some embodiments, an additional user action activates the selection, such as, by way of a non-limiting example, a mouse click. In some embodiments as long as the mouse button is pressed the gripping continues. In some embodiments a second mouse click terminates the selecting of the path.

In some embodiments, an additional user action activates the selection, such as, by way of a non-limiting example, a voice command “grip”. In some embodiments the toll tip is moved to a new location, and the 3D display moves the object gripped correspondingly.

In some embodiments, an additional user action activates a selection, such as, by way of a non-limiting example, a voice command “grip” or “select”. In some embodiments the tool tip is moved to a new location, and an additional voice command “move” causes the display to move the object gripped to a new point correspondingly.

In some embodiments, gripping an object, or touching an object in 3D display space is accompanied by feedback to the gripper. By way of a non-limiting example, the feedback is by blowing compress air at a finger which is touching an object, producing a sensation of touching in addition to a user viewing the touching. By way of another non-limiting example, the feedback is produced by a haptic glove.

An Example Embodiment of a 3D User Interface Command—Moving or Translating an Object in a 3D Scene

In some embodiments a 3D user interface command, such as the grip command described above, causes the 3D display to move a displayed object in display space. Optionally, the displayed object can be moved, or translated, anywhere in the display space.

In some embodiments coordinates of the input space are equal in scale to coordinates of the display space, so that moving an input object such as a hand or tool in input space causes a movement of the displayed object an equal distance and direction as the moving of the input object. In such embodiments, if the input object is moved, the displayed object appears to move as if attached to the input object.

In some embodiments, as described above, selection of a point on a displayed object is performed by “touching” the input object to the displayed object. When the coordinates of the input space are equal in scale to the coordinates of the display space, the displayed object appears to move as if attached to the input object at the point selected. The user interface implements a natural feeling of gripping an object and moving the object.

In some embodiments, as described above, selection of a point on a displayed object is performed by pointing the input object to the displayed object. When the coordinates of the input space are equal in scale to the coordinates of the display space, the displayed object appears to move as if attached to the input object by an optionally invisible connection.

In some embodiments, an optional additional command and/or interface setting causes a user input for moving to be implemented as moving along a specific direction, such as a specific axis, x, y or z, or a specific diagonal.

In some embodiments, and optional additional command and/or interface setting causes a user input for moving to be implemented as moving along a specific path, such as a path selected and/or defined as described above.

In some embodiments, an optional additional command and/or interface setting causes a user input for moving to be implemented as moving along a specific path, such as a path defined by a selected object. By way of a non-limiting example, the path for moving the object may be limited to moving along a blood vessel displayed by a 3D display of medical and/or anatomical data.

An Example Embodiment of a 3D User Interface Command—Auto-Centering an Object in a 3D Display Space

In some embodiments, and optional additional command and/or interface setting causes a selected object to be centered in the 3D display space.

Example Embodiments of 3D User Interface Commands—Zoom in and Zoom Out

In some embodiments, zoom commands are optionally implemented by hand gestures.

In some embodiments, the hand gesture for zooming is a bringing together or taking apart of finger tips in the input space.

In some embodiments, zoom out is implemented by bringing some or all fingers close to each other at a specific location in the input space, causing a zoom out relative to a corresponding location in image space; and zoom in is implemented by spreading some or all fingers which were held together at a specific location in the input space, causing a zoom out relative to a corresponding location in image space.

In some embodiments, zoom out is implemented by bringing tips of two fingers together at a specific location in the input space; and zoom in is implemented by spreading two fingers which were held together at a specific location in the input space, causing a zoom out relative to a corresponding location in image space.

In some embodiments, zoom out is implemented by bringing tips of three fingers together at a specific location in the input space; and zoom in is implemented by spreading three fingers which were held together at a specific location in the input space, causing a zoom out relative to a corresponding location in image space.

In some embodiments, zoom out is implemented by bringing tips of fingers of two hands together at a specific location in the input space; and zoom in is implemented by spreading fingers of two hands which were held together at a specific location in the input space, causing a zoom out relative to a corresponding location in image space.

In some embodiments, zoom out and zoom in are implemented by bringing a tool tip to a specific location in the input space and operating an additional input such as a mouse scroll or mouse button click.

In some embodiments, zoom out and zoom in are implemented by selecting a location within the input space, corresponding to a location in display space, and adding a voice command such as “zoom in” and “zoom out”.

In some embodiments, zoom out and zoom in are implemented by gripping two points of an image and changing a distance between the gripping points, for example by gripping with two hands and moving the hands.

In some embodiments, a user makes a C shape with a thumb and pointing finger in input space, and zooms a 3D image in display space by opening or closing the C shape.

An Example Embodiment of a 3D User Interface Command—Rotating an Object in a 3D Scene

In some embodiments, rotation of an object in a 3D scene is implemented by selecting an object, by any method such as described above, and providing a rotate command.

In some embodiments, the entire 3D scene rotated by providing a rotate command as described below.

In some embodiments, a hand provides a rotate command, and defines about which axis to perform the rotation, by performing a gesture in input space as follows: fingers 1, 2 and 3 are spread so as to form three approximately perpendicular axes.

Reference is now made to FIG. 4E, which is a simplified illustration of a hand 410 making a gesture for rotation 412 in an input space according to an example embodiment of the invention.

In some embodiments, a hand provides a rotate command, and defines about which axis to perform the rotation, by performing a gesture in input space as follows: fingers 1, 2 and 3 are spread so as to indicate three approximately perpendicular axes in input space. The hand then makes a rotation gesture, defining a rotation around one of the axes, which is input to the 3D display which rotates the selected object correspondingly.

In some embodiments, a hand provides a rotate command, and defines about which axis to perform the rotation, by performing a gesture in input space as follows: fingers 1, 2 and 3 are spread so as to indicate three locations in input space, which define a plane in input space. The hand then makes a rotation gesture, defining a rotation of the plane in input space, which is input to the 3D display which rotates the selected object correspondingly.

In some embodiments, rotation of an object in a 3D scene is implemented by gripping an object, by any method such as described above, and providing a rotate command.

In some embodiments, a hand provides a rotate command, and defines about which axis to perform the rotation, by performing a gesture in input space as follows: fingers 1 and 2 are spread so as to form an axis between the finger tips, and the other fingers are bunched up. The hand is then rotated around the axis. The 3D display rotates the selected object or the scene.

In some embodiments, a hand provides a rotate command, and defines about which axis to perform the rotation, by performing a gesture in input space as follows: all fingers are spread so as to place the finger tips more or less on a plane. The hand is then rotated around the plane. The 3D display rotates the selected object or the scene.

In some embodiments, two hands provide a rotate command, and define about which axis to perform the rotation, by performing a gesture in input space as follows: the two hands form a circle more or less on a plane. The two hands are then rotated around the plane. The 3D display rotates the selected object or the scene.

In some embodiments, two hands provide a rotate command, and define about which axis to perform the rotation, by performing a gesture in input space as follows: bunch four finger tips, such as 1, 3, 4 and 5, or 1, 2, 3 and 4, to define a point which acts as a center of rotation, and use one finger, such as 2 or 5 respectively, to indicate a rotation about the center of rotation.

In some embodiments, finger tips are closed at a point in the input space. When the closed finger tips are moved, the display space is rotated about a pre-specified point of origin, corresponding to a rotation of the point in input space relative to the pre-specified point of origin.

Optionally, the point of origin is highlighted, so the user can acquire a visual indication of the point of origin.

Optionally, the point of origin is a point of origin of display space coordinates.

Optionally, the axis of rotation is an axis selected from a menu, and the movement of the closed fingertips provides input as to how far to rotate.

Optionally the axis of rotation is highlighted.

Optionally, the axis of rotation is one of the main axes, x, y and z, of the display space coordinates.

In some embodiments, an axis of rotation is defined, optionally by selecting the axis of rotation from a menu, or by selecting an axis from a set of axes display by the 3D display, or by providing an indication of a direction by pointing a finger or an elongated tool. Additionally, a hand gesture marks a center of rotation. For example, closing finger tips at a point in the input space defines a location of the center of rotation. After closing the finger tips, rotating the hand provides input to the 3D display to rotate a scene by the same rotation angle. Optionally, and possibly in order to differentiate from other gestures which include closing the finger tips together, an additional input, such as a menu choice or a mouse click, is used to indicate to the 3D display that the user input commend is now a rotation input command.

In some embodiments, a hand gesture marks a center of rotation. Closing fingers tips at a point in the input space defines a location of the center of rotation. After closing the finger tips, rotating the hand provides input to the 3D display to rotate a scene by the same rotation angle. Optionally, and possibly in order to differentiate from other gestures which include closing the finger tips together, an additional input, such as a menu choice or a mouse click, is used to indicate to the 3D display that the user input commend is now a rotation input command.

In some embodiments, an axis of rotation is defined, optionally by selecting the axis of rotation from a menu, or by selecting an axis from a set of axes display by the 3D display, or by providing an indication of a direction by pointing a finger or an elongated tool. Additionally, a tool tip inserted into the input space marks a center of rotation. Rotating the tool provides input to the 3D display to rotate a scene by the same rotation angle.

In some embodiments, rotating is implemented by marking a point in an image by a tool tip, and providing a rotate command by a mouse click/voice command/eye blink. The display optionally rotates the image around the point marked according to the tool position with respect to that point. Optionally changing the tool angle rotates the image.

In some embodiments, a tool tip inserted into the input space defines a location of the center of rotation. Rotating the tool provides input to the 3D display to rotate a scene by the same rotation angle.

In some embodiments the above-mentioned rotation command input methods work with a voice command, the voice command optionally serving to indicate a moment when a finger tip, a tool tip, or several bunched up finger tips are at a center of rotation.

It is noted that in the above rotation command input methods a user may be shown where a selected center of rotation is by displaying a highlighted point in the display space. It is also noted, as described above, that selecting a point may also be done by pointing to the point on an object or in a scene.

In some embodiments, a user makes a C shape with a thumb and pointing finger in input space, and rotates a 3D scene and/or a 3D object in a 3D scene by rotating the C shape.

An Example Embodiment of a 3D User Interface Command—Combining Rotating and Translating an Object in a 3D Scene

It is noted that combining rotation and translation may be performed by combining user interface for rotation and translation, based on the above descriptions for rotation and translation.

An Example Embodiment of a 3D User Interface Command—Natural Gripping of an Object in a 3D Scene

In some embodiments, an object displayed in a 3D scene may optionally be gripped without providing a special grip activation command. When fingers tips are placed on a surface of an object, the object is selected by the user interface as gripped. Following a placing of several fingers of a user's hand on a surface of a displayed object, the user may move the hand, and the display moves the displayed object by an amount corresponding to the movement of the fingers, so the object appears to be gripped by the user's hand, and to be moved by the user's hand.

Similarly, a rotation of the displayed object is optionally performed corresponding to a rotation of the hand which is perceived to be gripping the displayed object.

In some embodiments, when one finger is placed on a surface of a displayed object, the displayed object is not considered as gripped, although the displayed object may be pushed, as described further below.

In some embodiments, when two fingers are placed on a surface of a displayed object, the displayed object is considered as gripped.

In some embodiments, when two fingers are placed on a surface of a displayed object, the displayed object is considered as gripped at the two touch points, defining an axis through the displayed object. Optionally, a third finger may be placed at the surface of the displayed object, and provide an input gesture which causes the display to rotate the displayed object in a direction which the third finger moves.

In some embodiments, it takes three fingers placed on a surface of a displayed object for the displayed object to be considered as gripped.

An Example Embodiment of a 3D User Interface Command—Pushing Displayed Objects in a 3D Scene

In some embodiments, a user inserts an input object, such as a tool or a hand, into the display space. The user moves the input object within the display space. An object which is displayed in display space acts as if solid in response to the input object, that is, the displayed object is moved in the display space so as not to occupy a location in display space corresponding to a location of said input object in input space.

An Example Embodiment of a 3D User Interface Command—Striking a Displayed Object in a 3D Scene

In some embodiments, a user inserts an input object, such as a tool or a hand, into the display space. The user moves the input object within the display space. An object which is displayed in display space acts as if solid in response to the input object, that is, the displayed object is perceived as if struck in the display space, optionally moving in a manner corresponding to a movement of an actual object being struck.

The displayed object may optionally be set to move as if it is a fully elastic object being struck, or a partially elastic object, or even a brittle object being struck and breaking.

Reference is now made to FIG. 4I, which is a simplified illustration of a user 460 inserting a tool 480 into a display and input space 462 of a volumetric display 466 according to an example embodiment of the invention.

It is noted with reference to FIG. 4I that the user 460 can easily see 470 and manipulate the tool 480 and guide it to a 3D object 482 which is being displayed, therefore potentially making the process of striking the 3D object 482 with the tool 480 simple and natural.

Location of one or more points of the tool 480 is optionally measured in the display and input space 462, as well as optionally a speed of movement of one or more points on the tool 480.

Location and dimensions of the displayed 3D object 482 in the display and input space 462 are known and/or calculated.

When a point on the tool 480 reaches coincidence with a point on the displayed 3D object 482, a speed and/or direction of movement of the point on the tool 480 in the display and input space 462 and a speed and/or direction of movement of the point of the displayed 3D object 482 in the display and input space 462 are optionally known and/or calculated.

When a point on the tool 480 reaches a point on the displayed 3D object 482, a vector normal to a surface of the tool 480 at the point is optionally calculated, and/or a vector normal to a surface of the displayed 3D object 482 at the point is optionally calculated.

In some embodiments speed of hand/tool at point of touch of displayed object is optionally measured, optionally being used to compute a response of the displayed object to the hand/tool.

In some embodiments the speed of the input object, or tool, or displayed object, is optionally measured by measuring location and time and calculating speed as distance travelled divided by time.

In an example embodiment, the tool 480 may be a tennis racket, and the displayed 3D object 482 may be a display of a tennis ball. The above example embodiment teaches how to potentially enable playing 3D virtual tennis. Such an interaction potentially enables a user to play a 3D interactive game.

The response of the displayed object to the hand/tool need not necessarily be as if the displayed object is a solid. Rather, it reacts as if it is physically there, whether, solid, liquid, gas or plasma. In some embodiments the response may include a deformation of the displayed object. In some embodiments a user may input physical and/or numerical parameters which describe a degree of elasticity and/or brittleness of the displayed object. In some embodiments a computer system producing a computer generated displayed object may optionally set the physical and/or numerical parameters which describe a degree of elasticity and/or brittleness of the displayed object according to data describing the object in the computer system.

Above-mentioned PCT Published Patent Application WO 2010/004563, now U.S. Pat. No. 8,500,284 describes two users interacting with a same displayed object in two separate display volumes, for example in FIG. 15 of the patent and in its description. Such an interaction in two display volumes potentially enables two users to play a 3D interactive game at two different locations.

Generalizing on the above description of a tennis game with a real racket and a displayed ball, other games may also potentially be played using an example embodiment of the invention.

A non-limiting list of such games includes:

Frisbee (real hand, displayed Frisbee). A real hand may optionally grip a displayed object such as a Frisbee, as described above in the section describing the example embodiment of “gripping an object”. The real hand may optionally move, or rotate, or flip, the displayed object Frisbee as described above in the section describing the example embodiment of “pushing displayed objects in a 3D scene”. The real hand may optionally release the displayed object Frisbee, and the displayed object Frisbee may optionally be seen moving as if actually thrown of flipped;

Table tennis (real paddle, displayed ball). A real tennis racket, real-sized or otherwise, may strike a displayed object ball;

Baseball or softball (real bat, displayed ball);

Marbles (one or more real marbles, one or more displayed marbles). A real marble may be shot into the display space and strike one or more displayed object marble(s), optionally causing the display system to display the displayed object marbles to move in the display space similarly to real marbles;

Shuffleboard (real paddle, displayed puck);

Knucklebones (real jacks, displayed ball). A displayed object ball may be gripped and/or struck in the display space, and display a trajectory upward and then back down similar to a real ball, or faster, or slower. While the displayed object ball is rising and falling, a user may optionally perform real manipulation of jacks according to the knucklebone game. The system optionally enables playing a beginner's game with a slowly rising and falling displayed object ball, a more advanced game with a realistic speed for the rising and falling displayed object ball, and optionally an even more advanced game with a faster-than-real speed for the rising and falling displayed object ball;

Bowling (real ball—actual or miniature or larger size, displayed pins); and

Pool or equivalent games (real cue stick, displayed ball(s)).

An Example Embodiment of a 3D User Interface Command—Moving Selected Displayed Objects and not Moving Non-Selected Displayed Objects in a 3D Scene

In some embodiments, a user optionally selects one or more objects displayed in a 3D scene, as described above. The user then inserts an input object, such as a tool or a hand, into the display space. The user moves the input object within the display space. Objects which are selected act as if solid in response to the input object, that is, the selected objects are moved in the display space when the input object touches against their corresponding images in image space. Objects which are not selected act as if transparent to touch in response to the input object, that is, the non-selected objects are not moved in the display space when the input object touches and/or passes through their corresponding images in image space.

An Example Embodiment of a 3D User Interface Command—Cropping or Slicing a Plane from a Scene or an Object in a 3D Scene

In some embodiments a user interface command is provided which causes a 3D object or a 3D scene to be sliced or cropped in a plane.

In a case of a slice command, by which is meant slicing the object or scene at a defined plane, optionally, one side of the plane may be deleted from the object/scene, and/or may be highlighted, and/or may be displayed at a different transparency than the other side of the plane.

In a case of a crop command, by which is meant slicing the object or scene at the defined plane, limited by a specific extent the defined plane, such as a rectangle, optionally, one side of the plane may be deleted from the object/scene, and/or may be highlighted, and/or may be displayed at a different transparency than the other side of the plane.

In some embodiments the crop or slice command does not crop or slice the 3D object or 3D scene, only highlights where the plane intersects with the 3D object or 3D scene.

In some embodiments, the 3D object or the 3D scene may be composed of more than one layer. A cropping user interface command may apply to one layer, to two layers, to selected layers, or to all layers.

In some embodiments, a combination of two hands provides a definition of the plane of the slicing or the cropping.

Reference is now made to FIG. 4F, which is a simplified illustration of two hands 415 with extended fingers 416 defining a shape of a rectangle 417 in an input space according to an example embodiment of the invention.

It is noted that the extended fingers 416 of the two hands 415 do not necessarily have to be touching in order to define the rectangle 417 between them. The altogether four fingers 416 define the sides of the rectangle 417.

It is noted that the rectangle 417 defines a rectangle for cropping, or a plane for slicing.

In some embodiments, a single hand (not shown) with fingers extended like the fingers of one hand in FIG. 4F defines a plane for slicing, or a plane and two edges of the plane.

Reference is now made to FIG. 4G, which is a simplified illustration of two hands 420 with extended fingers 421 defining a shape of a rectangle 422 in an input space according to an example embodiment of the invention. The extended fingers 421 define three edges of the rectangle 422 similarly to the definition depicted in FIG. 4F, and a line between tips of the open-ended fingers defines a fourth edge of the rectangle 422.

In some embodiments, three points are defined in the input space. The three points define a plane, which is optionally used for slicing an object or an image.

In some embodiments, three points are defined in the input space. The three points define a plane, and also a triangle, which is optionally used for cropping an object or an image.

In some embodiments, the 3D display displays a sliced or cropped object or scene, and when an input object which defines the plane is moved, altering the position or direction of the plane, the 3D display displays the sliced or cropped object according to the new plane.

In some embodiments, a tool optionally inserted into input space provides a definition of the plane of the slicing or cropping.

In some embodiments the tool is rod-shaped, and the direction of the long axis of the rod optionally defines a plane perpendicular to the direction. A point on the rod optionally defines which of many parallel planes is actually to be used. In some embodiments, the point on the rod-shaped tool is the tip of the rod-shaped tool.

In some embodiments the tool is rectangle-shaped. In some embodiments the rectangle defines a plane to be used for slicing. In some embodiments, the rectangle-shaped tool defines a rectangle used for cropping. In some embodiments, the plane is an adjustable-sized rectangle.

In some embodiments the tool is rod-shaped, and the direction of the long axis of the rod optionally defines a cutting line. When a user activates a slicing mode, moving the rod-shaped tool slices the 3D object or 3D scene along the cutting line.

In some embodiments a voice command such as “crop” or “slice” activates cropping and/or slicing when a cropping or slicing have been defined.

In some embodiments a predefined orientation of a cropping or slicing plane is selected, such as, by way of a non-limiting example, horizontal or vertical, a point within the 3D scene is selected, and a crop or slice command is input based on the predefined direction of the plane and the location of the selected point.

In some embodiments, when a 3D scene includes more than one category of objects, as recognized by a computer generating a display of the 3D scene, a crop or a slice command applies to a specific category of object. For example, when the 3D scene displayed is a medical scene, an object cropped or sliced may optionally be a specific organ in the medical image, and/or a specific system (such as bones, muscles, blood vessels) in the medical image.

An Example Embodiment of a 3D User Interface Command—Selecting a Volume in a 3D Scene

In some embodiments a user interface command is provided which defines a volume in 3D display space, corresponding to a specific volume in a 3D scene.

In some embodiments, the volume is a volume between two finger tips held somewhat apart in input space.

In some embodiments, the volume is a volume between two hands held somewhat apart in input space.

In some embodiments, the volume is a volume between two cupped hands.

In some embodiments, the volume is a volume within one cupped hand.

An Example Implementation of a 3D User Interface Embodiment—Sculpting a 3D Object in a 3D Scene

In some embodiments, a tool, such as a chisel, a knife, or a freeform sculpting tool is inserted into input space. A tracking system tracks a tip of the chisel, or edges of the sculpting tool or knife in input space. The tip of the chisel or the edges of the sculpting tool or knife are hereby termed the active portion of the tool. In some embodiments, the tip of the chisel, or the edges of the sculpting tool, are painted or marked to assist the tracking system to track in input space. When the tool is moved within input space, and moves into a location in input space which correspond to a location of an object in display space, a portion of the object in display space is optionally erased, as if the active portion of the tool is removing the portion of the object in display space.

In some embodiments, the portion of the object in display space is optionally highlighted instead of erased. Optionally, a command to erase the highlighted portion causes the highlighted portion, which could be considered as marked-for-erasing, to be erased.

In some cases, the above interface optionally simulates a process of sculpting in a 3D display, optionally before performing an actual such sculpture in the real world, potentially enabling a planning and simulation of an operation before actually performing the operation.

The above simulation is considered especially useful in medical situation, for example before surgery, when a 3D display of a medical set of a patient's body can be used. Another example medical embodiment is for teaching, when a student can perform a virtual surgery on a 3D display of a medical set of a patient's body.

Real tools which may be used in sculpting according to the above description include, by way of a non-limiting example, pointed tools, sharp-edged tools, brushes, clay shaping tools, and so on.

In some embodiments, the tool is a virtual tool, that is, a tool displayed as a 3D object in the 3D display. A user optionally grips the tool properly, by placing a hand or fingers at appropriate locations in input space corresponding to appropriate locations in display space for gripping the tool. Gripping according to example embodiments of the 3D user interface is described in more detail hereinabove.

In such embodiments the tracking system optionally tracks the user's hand rather than the tool.

When the user grips the virtual tool, movements of the user's hand in input space, cause the user interface to move the virtual tool in display space. Movements of the active portion of the virtual tool through a portion of a displayed object in display space optionally enable sculpting as described above with a real tool, erasing or highlighting a portion of the displayed object.

In some embodiments virtual tools are picked from a library of tools, some or all of which may be displayed by the 3D display, by a mouse click or by selecting from a virtual menu.

In some embodiments the active portion of the virtual tool is highlighted.

Virtual tools which may be used in sculpting according to the above description include, by way of a non-limiting example, pointed tools, sharp-edged tools, brushes, clay shaping tools, and so on, and, furthermore, some tools which can exist in a display space but not in the real world, such as tools which include two or more parts which are virtually connected, but not actually connected. For example—a sharp ring within a sharp ring without a connecting section holding the inner ring within the outer ring can be implemented as a virtual tool but not as a real tool.

In some embodiments, the tool is a combination of a real tool and a virtual tool. A real tool is inserted as an input object into the 3D display space, and the real tool is enhanced by a displayed addition to the real tool.

In some embodiments, the enhancement is performed by the 3D display displaying an addition to the tool at the tip of the tool. By way of a non-limiting example, a tool is inserted, and the tool is displayed to be elongated by adding to the tip of the tool. The displayed elongation moves with the real tool as if attached to the tool. By way of a non-limiting example, a tool handle is inserted, and the tool tip, or working part, is selected from a menu of tool tips, and displayed by the 3D display as if attached to the tool handle.

An Example Embodiment of a 3D User Interface Implementation—Producing a 3D Object in a 3D Scene

In some embodiments a 3D object in a 3D scene is produced, or built up. Optionally, an initial 3D scene may be empty of objects, and the 3D object may be built from scratch.

In some embodiment, a tool or a hand is inserted into input space. A command is optionally provided to initiate producing the object, and from that moment until a command to stop producing is given, the volume which the tool or hand sweeps through is optionally detected and displayed as an object in the 3D display space.

In some embodiments, it is not the entire volume of the tool or hand, but a specific portion of the tool or hand, designates as an active portion.

In some embodiments, the active portion is highlighted in display space, to provide visual indication to a viewer of the active portion.

An Example Embodiment of a 3D User Interface Implementation—Producing or Altering a 3D Object in a 3D Scene, and Sending the Object to a 3D Printer

In some embodiments a 3D object in a 3D scene is altered, or a 3D object is sculpted (as described above), and the 3D object is as output for production to a 3D printer.

An Example Embodiment of a 3D User Interface Command—Highlighting an Object Inserted into the 3D Display Space

In some embodiments, the 3D input space and the 3D display space overlap, as mentioned above. In such cases, the 3D display may optionally be used to display at a location of an input object inserted into the 3D display and input space.

A non-limiting example includes displaying a different color and/or a different icon at a tip of a finger or a tool. The color and/or icon may travel with the tip of the finger or tool wherever the finger or tool are moved within the 3D display space. The display can optionally serve to mark that the tip of the finger or tool is active (in contrast to inactive), or to indicate what the finger or tool may be used for within the 3D interface. In some embodiments, a menu may be displayed by the 3D display, and a menu choice be made by touching or pointing a tip of an input object. The menu selection optionally causes a highlight, or a specific color corresponding to the menu choice, or an icon, to follow the tip of the input object in display space.

In some embodiments a virtual object is selected from a list of virtual objects, and the virtual object is displayed at a tip of a tool. Similarly, after selecting an object, a real such object is optionally inserted into input space, optionally identified by the system, and the edges of the object are optionally highlighted, following the tool's position.

In some embodiments, by way of a non-limiting example, a menu is optionally displayed at finger tips of an inserted hand. Touching one of the finger tips to an object causes the 3D input to accept a menu choice as applied to the object touched. When the menu choices are different colors, the object may be displayed with the color. When the menu choices are “cut” and “copy”, the object may optionally be cut from a 3D scene, or copied.

In some embodiments, a button may be displayed by the 3D display, and actuating the button may optionally be made by touching the button in display space, or pointing a tip of an input object at the button in display space.

In some embodiments, the button may be displayed as a three dimensional button. In some embodiments the button may be displayed as a 2D display.

In some embodiment the button may display a reaction to a touching of the button, as if pressed. In some embodiments the button may optionally simply be highlighted, not necessarily displayed as if pressed.

An Example Embodiment of a 3D User Interface Command—Measuring a Distance in a 3D Scene

In some embodiments a distance is measured between two selected points in a 3D scene.

In some embodiments two fingers are placed to select the two points, and a measure-distance command is given, by a wink, or by a voice command, or by button activation.

In some embodiments a single finger is used to select the two points, and a measure-distance command is given, by a wink, or by a voice command, or by button activation.

In some embodiments a tool is used to select the two points, and a measure-distance command is given, by a wink, or by a voice command, or by button activation.

In some embodiment the distance measured is a straight line distance in the 3D display space.

In some embodiment, and in specific cases, such as when the two points are points on a surface of an object, the distance measured is a shortest distance on the surface of the object in the 3D display space. For example, when a sphere, such as a globe map of the world is displayed, selecting two points, such as two cities, on the face of the sphere and optionally measuring shortest distance on the face of the sphere provides a great circle distance.

An Example Embodiment of a 3D User Interface Command—Measuring a Volume in a 3D Scene

In some embodiments a volume of one or more selected objects is measured in a 3D scene.

In some embodiments the one or more objects are selected as described above with reference to selecting, and a measure volume command is provided, by a wink, or by a voice command, or by button activation.

In some embodiments, the volume is already segmented from a rest of a 3D scene, by way of a non-limiting example an automatic segmentation of a 3D medical image such as a CT image.

In some embodiments a plurality of points in the 3D scene, not all in one plane, are selected, as described above with reference to selecting, and a measure volume command is provided, by a wink, or by a voice command, or by button activation. The volume measured is optionally the volume contained within surfaces defined by the points.

In some embodiments the points are allowed to snap to nearby nearest surfaces of objects in the 3D scene, in order to facilitate actually marking boundaries of a displayed object.

In some embodiments a surface defined by the points in display space is allowed to collapse onto nearest surfaces of an object in the 3D scene, in order to facilitate selecting the object, similarly to drawing a “lasso” around a 2D object in selecting a 2D object in 2D drawing software.

In some embodiments a volume for measurement is selected by marking a center point, by the methods described above for marking a point, then moving a point marker to another point which marks a spherical surface, similar to selecting a center and a radius in 2D drawing software. The volume measured may be the volume of the sphere, and/or optionally the surface of the sphere may be activated to collapse and conform onto a displayed object surface within the sphere, and the volume enclosed within the collapsed surface is measured.

In some embodiments selecting the points is done by a finger tip. In some embodiments selecting the points is done by a tool tip.

An Example Embodiment of a 3D User Interface Command—Measuring an Area in a 3D Scene

In some embodiments an area is measured in a 3D scene.

In some embodiments three or more points are selected as described above with reference to selecting points in a 3D display, and a measure-area command is given, by a wink, or by a voice command, or by button activation.

In some embodiments a single finger is used to select the points, and a measure-area command is given, by a wink, or by a voice command, or by button activation.

In some embodiments a tool is used to select the points, and a measure-area command is given, by a wink, or by a voice command, or by button activation.

In some embodiment the area measured is an area in a plane defined by three points in the 3D display space.

In some embodiment, and in specific cases, such as when the points are points on a surface of an object, the area measured is the area on the surface of the object in the 3D display space. For example, when a sphere is displayed, selecting three points on the face of the sphere and measuring area provides the area of a triangle defined by the three points on the face of the sphere.

Optionally more points around a circumference of the area are marked, potentially increasing accuracy of the measurement and calculation. In some embodiments edges of a measured area are determined by image contrast, edge detection or similar method for determining boundaries of the desired area to be measured.

In some embodiments, an object is selected using the methods described above with reference to measuring a volume of the object, and the object surface area is optionally measured.

An Example Embodiment of a 3D User Interface Command—Comparing Dimensions of a First 3D Object with Reference to a Second 3D Object Displayed in a 3D Scene

In some embodiments a first, real world 3D object is placed into an input space, at a location corresponding to a display of a second 3D object whose image is generated by the 3D display.

In some embodiments, as described above, the input space overlaps the display space, and the first 3D object is placed into the display of the second virtual object.

Reference is now made to FIG. 4H, which is a simplifies illustration of a user 450 inserting a first 3D object 456 into a display of a second 3D object 454 in a common display and input space 452 according to an example embodiment of the invention.

It is noted with reference to FIG. 4H that the user 450 can easily see and manipulate the first 3D object and align it to the second 3D object which is being displayed, therefore potentially making the process of comparing the two objects simple and natural.

Location and dimensions of the first 3D object are measured in the display space, and compared to the location and dimensions of the second 3D object.

A result of comparing the dimensions may optionally include: distances between surfaces, averages distance between surfaces, volume fitting between surfaces of the objects, and so on.

In some embodiments a first 3D object is also an object generated and displayed by the 3D display. The first 3D object is gripped and translated and/or rotated by input commands in the input space, to a location corresponding to a display of the second 3D object whose image is generated by the 3D display. By way of a non-limiting example, the first 3D object may be selected from a menu or library of generated objects, displayed at some point within the display space, and gripped and moved to a location appropriate for comparing to the second 3D object.

It is noted that FIG. 4H is suitable for depicting the scenario of the first 3D object also being a generated object in 3D display space.

In some embodiments an area or a volume are defined by selecting and marking points in display space, and inserting a 3D object, real or generated, into the area or volume defined. Location and dimensions of the 3D object are measured and compared to the location and dimensions of the defined area or volume. A result of comparing the dimensions may optionally include: distances between surfaces, averages distance between surfaces, volume fitting between surfaces of the objects, and so on.

An Example Embodiment of a 3D User Interface Command—Comparing Dimensions of a First 3D Object with Reference to a Path Displayed in a 3D Scene

In some embodiments a path is defined in display space as described above. A 3D object, real or generated, is gripped and moved along the path. Measurements are made while the 3D object is moved along the path, and results are generated.

The measurement may include, for example, whether the 3D object may at all times be included completely within the path. By way of a non-limiting example, the path may be a manually marked blood vessel in a medical image, or may be an automatically generated path along the length of the blood vessel, and measurements may be made as to the distance between the surface of the 3D object and the surface of the blood vessel, providing an answer as to whether the object can be made to pass along the blood vessel without getting stuck. By way of another non-limiting example, the cross sectional area between the 3D object and the path, or blood vessel, walls may be measured, providing an answer as to what percentage of the path cross section is blocked by the 3D object at any point.

An Example Embodiment of a 3D User Interface Command—Moving a 3D Object Along a Path Displayed in a 3D Scene

In some embodiments, a 3D object, whether a real 3D object inserted into input space and measured by a tracking system or a virtual 3D object displayed in display space, is moved along a path marked as previously described above.

In some embodiments, the 3D object is moved through a 3D scene, itself including additional 3D objects.

In some embodiments the 3D object moving through the 3D scene causes the 3D display to move aside the additional 3D objects in the 3D scene so that the 3D object does not pass through the additional 3D objects but rather appears to move them aside.

In some embodiments the 3D object moving through the 3D scene causes the 3D display to deform the additional 3D objects in the 3D scene so that the 3D object does not pass through the additional 3D objects but rather appears to deform them.

In an example implementation of an embodiment as described above a user optionally insert a stent into a 3D medical scene displaying one or more blood vessels. A tracking system identifies the location of the stent, and causes an image of a blood vessel apparently wrapping the stent to deform so as to contain the shape of the stent.

An Example Embodiment of a 3D User Interface Command—Co-Registering Two 3D Images

Manual Registration:

In some embodiments, a first 3D object and a second 3D object are displayed in display space. A user inserts hands into input space and grips one or both of the displayed 3D objects, in the sense of gripping a displayed object which is described above. The user optionally manipulates one or both of the displayed 3D objects to obtain a degree of registration between the two displayed objects.

Optionally, the user indicates that the two displayed 3D images are registered, and/or approximately registered.

In some embodiments, the user releases, or un-grips, the two displayed 3D images, and marks points on the two displayed 3D images which the user intends to be used for registering the two displayed 3D images.

In some embodiments, after the user indicates that the two displayed 3D images are approximately registered, a computer system recognizes similar points in the two displayed images, and the computer system places the two images in a way that the same points in the two images are in maximal proximity, and/or that the two displayed images maximally overlap each other.

It is noted that the registration optionally involves translation and/or rotation and/or zooming of one or more of the displayed objects.

In an example implementation of an embodiment as described above a user optionally performs the above manipulation of two displayed images with the two displayed images optionally being a registration between medical images of a same object from a different acquisition system.

Semi-Manual Registration and Display of Registration:

In some embodiments a user marks a plurality of points on a first displayed 3D image of an object; a plurality of corresponding objects on a second displayed 3D image of the same object; and a computer system optionally moves, and/or rotates, and/or zooms the first displayed image of an object to overlap and register with the second displayed image of the same object.

In some embodiments the user uses a tool to mark, as described above with reference to marking points in the 3D display space, and the computer system performs the registration as described above.

In an example implementation of an embodiment as described above a user optionally co-registers two 3D images of a beating heart captured at two different moments in time. In some implementation an E.C.G. signal is used to determine at what stage during a beating heart cycle the two 3D images of a beating heart were captured.

In an example implementation of an embodiment as described above a user optionally co-registers a 2D image to a 3D image, where the 2D image is potentially captured by a different modality that the 3D image. The user optionally marks points on the 3D image which correspond to specific points on the 2D image.

An Example Embodiment of a 3D User Interface Command—Exploring a 3D Scene, or Moving a Viewpoint within a 3D Scene

In some embodiments, the user interface enables a user to explore a 3D scene by marking a point and a direction in the 3D scene, and providing input to the display to display the 3D as viewed from the marked point and in the direction indicated.

In some embodiments, the marking a point and a direction in the 3D scene is performed by inserting an elongated input object into the display space, as described above with reference to marking a point and to indicating a direction.

In some embodiments a tracking system tracks location and orientation of the input object over time, making changes in viewpoint and view direction corresponding to changes in the location and orientation of the input object.

In some embodiments, an implementation of the above-described method enables a user to switch from viewing a 3D scene from a viewpoint outside the 3D scene to a viewpoint within the 3D scene.

In some embodiments, an implementation of the above-described method enables a user to move a viewpoint within the 3D scene along a path as indicated by the input object, and view the 3D scene as if travelling along the path within the 3D scene.

In some embodiments, an implementation of the above-described method enables a user to move a viewpoint along a predefined path within the 3D scene, where marking a path may optionally be performed as described above.

By way of a non-limiting example, a view direction along a path for inserting a stent is optionally chosen to be in a direction of a propagating stent's tip. The viewer is presented with a display of a 3D medical image within which a stent (a virtual stent image or a real stent inserted into the 3D medical image space) is traveling, resembling “head-on navigation” used in GPS systems, where a map rotates according to the orientation of a viewer (e.g. with respect to North).

An Example Embodiment of a 3D User Interface Command—Selecting a 3D Object or Portion of a Scene and Sending Information to a Different System

In some embodiments, the 3D user interface described above is used to select one or more objects in a 3D scene, or select a portion of a 3D scene, and send information about the objects or portion of the scene to a different system.

In some embodiments the information may be data for displaying the objects or scene portion.

In some embodiments the information may be coordinates for of the objects or scene portion, optionally including a request for data from the different system regarding the objects or scene portion. By way of a non-limiting example, requesting higher resolution data for displaying the objects or scene portion. By way of another non-limiting example, requesting the objects or scene portion to be stored in a system, for example medical.

An Example Embodiment of a 3D User Interface Command—Rotating a 3D Scene

In some embodiments an entire 3D scene is rotated based, at least in part, on tracking an input object in input space. An input object is inserted into input space and rotated. The 3D scene is rotated around an axis corresponding to a direction defined by the input object as described above, and by an angle corresponding to the angle which the input object rotated. The input object may optionally be a hand or a tool.

An Example Embodiment of a 3D User Interface Command—Interfacing with Medical Systems

Various medical systems which already acquire, or present, 3D medical data, such as CT (computerized tomography), MRI (magnetic resonance imaging), Electrophysiology 3D mapping systems (such as the Carto 3 system from Biosense Webster, Inc), US (ultrasound), and 3D Rotational Angiography (3DRA) potentially benefit from using a 3D display and a 3D interface according to an example embodiment of the invention. User interfaces for such 3D acquisition systems, even keyboards, include functions which are optionally transmitted to embodiments of the 3D user interfaced.

One example function is MPR (Multi-planar reformatting or multiplanar reconstruction), a term used in medical imaging to refer to reconstruction of images in the coronal and sagittal planes in conjunction with an original axial dataset. The function is optionally provided by marking a point in a 3D image according to an example embodiment, and having the 3D interface automatically slice the 3D image and displays the coronal and sagittal planes at the point. Such a function is potentially useful, by way of a non-limiting example, in MRI and CT.

One example function is providing an input for adjustment of image quality by moving a hand or tool across a 3D image, after providing a command such as changing a histogram by changing a gamma function used for displaying the 3D image, or changing contrast of the display of the 3D image. Such a function is potentially useful in, by way of a non-limiting example, 3DRA, CT and MRI.

One example function is providing an input for adjustment of image quality by selecting what is termed a window level in CT images. The 3D image is optionally enhanced between specific levels of voxel grey levels. The windows, or grey level ranges, are optionally used to enhance specific objects, and in the case of medical images, specific medical systems such as brain, lung, bone, and so on. In some embodiments the window of grey levels for enhancement is optionally defined by selection from a menu of windows. In some embodiments the window is optionally defined by hand or tool movement for defining a top level and a bottom level for the window, or by using an external input such as a mouse for defining the top level and the bottom level for the window.

One example function is selecting which organs or medical systems are to be displayed in a 3D medical image, by way of a non-limiting example, displaying bones while not displaying the vascular system, in a CT image.

One example function is scrolling thru a 3D volumetric loop by moving a hand, finger or tool along a time line displayed by the 3D display. Such a function is potentially useful in, by way of a non-limiting example, 3D ultrasound; fused images coming from two or more modalities, such as the EchoNavigator system (Royal Philips Electronics, Netherland) which fuses live X-ray and 3D ultrasound images in real time for cardiovascular procedures of Fast Anatomical Mapping; and display of a system such as Carto System, by Biosense Webster, which fuses 3-D Electrical Mapping of the Heart over pre-acquired 3D CT-based images. In such systems, a viewer optionally has an ability to move points within a displayed 3D image so as to change their position in an acquisition module.

One example function is selecting which organs, segments of organs, or medical systems are to be displayed in a 3D medical image, and in what color or what type of highlight. By way of a non-limiting example, such a function is termed “cropping an organ” displaying bones while not displaying the vascular system, in a CT image.

One example function is measuring a surface area of a selected volume or object or medical system or medical organ. Optionally, surface of the selected object is automatically detected by edge detection. Such a function is potentially useful in, by way of a non-limiting example, CT and 3DRA.

One example function is fitting a physical object to a medical 3D image, such as, by way of a non-limiting example, fitting a valve for a Transcatheter Aortic Valve Implantation (TAVI). The correct valve potentially prevents paravalvular leaks following the TAVI.

One example function is registering, or super imposing, two images (co-registration). By way of a non-limiting example, such a function is potentially helpful when working with multi-modal images. For example, performing semi-manual registration such as in AFIB registration of intra-procedural 3D-RA based left atrium with CT based pre-enquired left atrium/Electroanatomical map/Ultrasound 2d or 3d TEE or ICE, as described in above-mentioned “Intracardiac echocardiography for registration of rotational angiography-based left atrial reconstructions: a novel approach integrating two intraprocedural three-dimensional imaging techniques in atrial fibrillation ablation”, and/or in above-mentioned “Intraprocedural imaging of left atrium and pulmonary veins: a comparison study between rotational angiography and cardiac computed tomography”.

One example function is co-registering 2D x-ray planes on 3D Ultrasound images such as obtained from the EchoNavigator system by Royal Philips Electronics, Netherland.

One example function is localization by moving of a virtual valve image on a CT/3DRA image to evaluate valve placement for TAVI.

An Example Embodiment of a 3D User Interface Command—Interacting with a Displayed Model

In some embodiments, the 3D scene or object being displayed is a computer model of a dynamic system, such as of a medical system, an engine, an airplane in a wind tunnel, a computer game, and so on, and the user interacts with the model by using hands, fingers, or tools in the 3D image to cause actions to occur in the model and to be displayed by the 3D display.

By Way of Some Non-Limiting Examples:

a finger may be inserted into a model of a vascular system, and the 3D display optionally gradually highlights the vascular system downstream of the finger, similarly to how a contrast material would highlight blood flow in an angiogram;

a finger can be inserted into a model of a vascular system and the 3D display optionally shows blood flow stopped at a position the finger is indicating;

a finger can be inserted into a model of a vascular system and used to push (as described elsewhere) the walls of a blood vessel, and the 3D display optionally shows the model of the blood flow through the enlarged vessel; and

fingers can be inserted into a model of a vascular system and used to pinch (by pushing, as described elsewhere) the walls of a blood vessel, and the 3D display optionally shows the model of the blood flow through the pinched vessel.

### A Further Description of Some Example Embodiments of the Invention

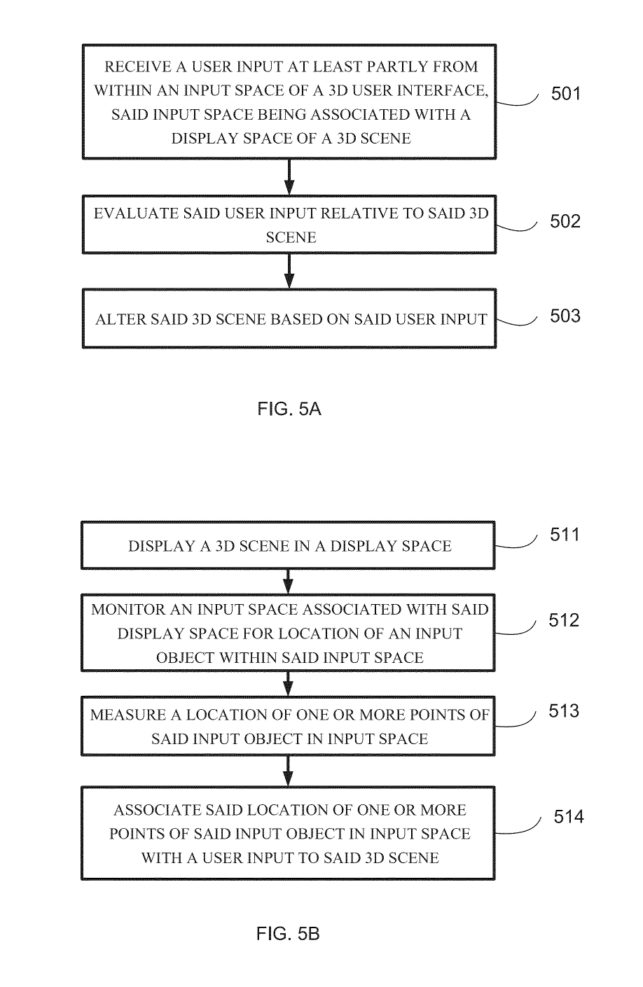

Reference is now made to FIG. 5A, which is a simplified flow chart illustration of an example embodiment of the invention.

FIG. 5A depicts a method of providing a three dimensional (3D) user interface which includes:

receiving a user input at least partly from within an input space of said 3D user interface, said input space being associated with a display space of a 3D scene (501);

evaluating said user input relative to said 3D scene (502);

altering said 3D scene based on said user input (503).

Reference is now made to FIG. 5B, which is a simplified flow chart illustration of an example embodiment of the invention.

FIG. 5B depicts a method of receiving user input to a display of a 3D scene which includes:

displaying a 3D scene in a display space (511);

monitoring said an input space associated with said display space for location of an input object within said input space (512);

measuring a location of one or more points of said input object in input space (513);

associating said location of one or more points of said input object in input space with a user input to the 3D scene (514).

Some Example Uses of a 3D User Interface

In some embodiments a 3D interface is used as a natural interface for viewing medical data and images, and planning medical treatment.

By way of a non-limiting example, a roadmap for ablation, that is, a selection of ablation points on a subject body is optionally laid out using a 3D interface to mark the ablation points on a 3D image of a body.

By way of a non-limiting example, selecting 3D objects in a 3D scene and performing measurements of the 3D objects is naturally done via an environment of a 3D display.

It is expected that during the life of a patent maturing from this application many relevant 3D displays will be developed and the scope of the term 3D display is intended to include all such new technologies a priori.

It is expected that during the life of a patent maturing from this application many relevant eye tracking, viewer tracking and object tracking technologies will be developed and the scope of the terms eye tracking, viewer tracking and object tracking in all their grammatical forms is intended to include all such new technologies a priori.

As used herein the term “about” refers to ±10%.

The terms “comprising”, “including”, “having” and their conjugates mean “including but not limited to”.

The term “consisting of” is intended to mean “including and limited to”.

The term “consisting essentially of” means that the composition, method or structure may include additional ingredients, steps and/or parts, but only if the additional ingredients, steps and/or parts do not materially alter the basic and novel characteristics of the claimed composition, method or structure.

As used herein, the singular form “a”, “an” and “the” include plural references unless the context clearly dictates otherwise. For example, the term “a unit” or “at least one unit” may include a plurality of units, including combinations thereof.

The words “example” and “exemplary” are used herein to mean “serving as an example, instance or illustration”. Any embodiment described as an “example or “exemplary” is not necessarily to be construed as preferred or advantageous over other embodiments and/or to exclude the incorporation of features from other embodiments.

The word “optionally” is used herein to mean “is provided in some embodiments and not provided in other embodiments”. Any particular embodiment of the invention may include a plurality of “optional” features unless such features conflict.

Throughout this application, various embodiments of this invention may be presented in a range format. It should be understood that the description in range format is merely for convenience and brevity and should not be construed as an inflexible limitation on the scope of the invention. Accordingly, the description of a range should be considered to have specifically disclosed all the possible sub-ranges as well as individual numerical values within that range. For example, description of a range such as from 1 to 6 should be considered to have specifically disclosed sub-ranges such as from 1 to 3, from 1 to 4, from 1 to 5, from 2 to 4, from 2 to 6, from 3 to 6 etc., as well as individual numbers within that range, for example, 1, 2, 3, 4, 5, and 6. This applies regardless of the breadth of the range.

Whenever a numerical range is indicated herein, it is meant to include any cited numeral (fractional or integral) within the indicated range. The phrases “ranging/ranges between” a first indicate number and a second indicate number and “ranging/ranges from” a first indicate number “to” a second indicate number are used herein interchangeably and are meant to include the first and second indicated numbers and all the fractional and integral numerals therebetween.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable sub-combination or as suitable in any other described embodiment of the invention. Certain features described in the context of various embodiments are not to be considered essential features of those embodiments, unless the embodiment is inoperative without those elements.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims.

All publications, patents and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present invention. To the extent that section headings are used, they should not be construed as necessarily limiting.

1-51. (canceled)

52. A method of providing a three dimensional (3D) user interface comprising:
receiving a user input by locating an input object placed at least partly into an input space of said 3D user interface, said input space comprised within a display space of a 3D computer generated holographic (CGH) scene;
evaluating said user input relative to said 3D CGH scene; and
altering said 3D CGH scene based on said user input.

53. The method of claim 52 in which said input object comprises a user's hand and said user input comprises a shape in which said user forms said hand.

54. The method of claim 53 in which:
said locating comprises locating a plurality of points on said input object;
said receiving a user input comprises selecting a plurality of locations in display space corresponding to said plurality of points on said input object; and
said selecting a plurality of locations in display space comprises selecting said plurality of locations in display space on a surface of a displayed object,
thereby providing a user input of gripping said displayed object.

55. The method of claim 52 in which said input object comprises an elongated input object, and a long axis of said input object is interpreted as defining a line which passes through said long axis and extends into said input space.

56. The method of claim 55 in which said user input comprises selecting a location in input space corresponding to a location in display space by determining where said line intersects a surface of an object displayed in display space.

57. The method of claim 56 and further comprising visually altering the display of a location in display space at which said line intersects a surface of the object displayed in display space, so as to display the selected location in display space.

58. The method of claim 55 in which said user input comprises using said line to determine an axis of rotation for a user input of a rotation command.

59. The method of claim 58 and further comprising said user rotating said input object, and rotating said 3D scene by an angle associated with the angle of rotation of said input object.

60. The method of claim 52 in which, when said input object moves into a location in input space corresponding to a location of said displayed object in display space, a deformation of the displayed object is displayed so that said input object does not pass through said displayed object but rather appears to deform said displayed object.

61. The method of claim 52 in which when a point on said input object reaches a location in input space corresponding to a location of said displayed object in display space, a speed of movement of said point on said input object is measured and a direction of a vector normal to a surface of said input object at said point is calculated.

62. The method of claim 61 in which said displayed object is displayed to appear as moving as if the displayed object were actually struck by said input object at said point on said displayed object at said measured speed of said point on said input object in a direction of said vector.

63. The method of claim 52 in which when a point on said input object reaches a location in input space corresponding to a location of said displayed object in display space, a speed of movement of said point on said displayed object is measured and a direction of a vector normal to a surface of said displayed object at said point is calculated.

64. The method of claim 63 in which said displayed object is displayed as moving as if struck by said input object at said point on said displayed object at said measured speed of said point on said input object in a direction of said vector.

65. The method of claim 54 in which a gripping of a displayed object in display space causes said user interface to locate said displayed object in display space so as to track said plurality of locations on said surface of a displayed object at said plurality of points on said input object.

66. The method claim 52 and further comprising deforming a shape of a 3D object displayed in the 3D display space by moving said input object through a volume of said 3D object.

67. The method claim 52 and further comprising altering a shape of a 3D object displayed in the 3D display space by moving said input object through a volume of said 3D object, and displaying said 3D object minus said volume in said 3D object.

68. The method of claim 67 and further comprising passing said input object through at least a portion of a volume of a 3D object displayed in the 3D display space, and displaying said 3D object minus said portion of the volume.

69. The method of claim 68 in which said displaying said 3D object comprises displaying said 3D object minus only a portion of the volume through which an active region of said input object passed.

70. The method of claim 67 and further comprising passing said input object through at least a portion of said input volume, and displaying said 3D scene plus an object displayed in display space corresponding to said portion of said input volume.

71. The method of claim 70 in which said displaying said 3D object comprises displaying said 3D object plus only a portion of the volume through which an active region of said input object passed.

72. The method of claim 52 in which said user input further comprises detecting a snapping of fingers by tracking said fingers in input space.

73. A method of providing input to a 3D (three dimensional) display comprising:
inserting an input object into an input space with a volume of said 3D display;
tracking a location of said input object within said input space;
altering a 3D scene displayed by said 3D display based on said tracking,
in which said tracking location comprises interpreting a gesture and
in which said input object is a hand, and said gesture comprises shaping three fingers of said hand as three approximately perpendicular axes in 3D input space, and rotating said hand around one of said three approximately perpendicular axes.
